(19) United States
(12) Patent Application Publication
(10) Pub. No.: US 2007/0090553 A1
(43) Pub. Date: Apr. 26, 2007

(54) Method for Preparing a Polymeric Article

(76) Inventor: Robert Bordener, Bloomfield Hills, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/562,172

(22) Filed: Nov. 21, 2006

Related U.S. Application Data
(62) Division of application No. 10/737,512, filed on Dec. 16, 2003.
(60) Provisional application No. 60/434,334, filed on Dec. 17, 2002.

(51) Int. Cl. B29C 41/22; B29C 47/00; B29C 69/00; B05D 1/12; B05D 7/00

(52) U.S. Cl. 264/73; 264/75; 427/180; 427/421.1

(57) ABSTRACT

A method for preparing a polymeric article including the steps of admixing a visually differentiable granule-based coloring system into a fluidic polymeric base material, such as by coextruding, co-laminating, or injection molding. An applied hydraulic force, such as applied along a planar direction and in cooperation with a separate linear directed hydraulic force associated with a sheet article formation step, causes associated and high aspect granules to align in substantially parallel and evenly dispersed fashion. A further step includes “roughening” the surface of the article created, such as by the removal of a selected thickness of material to reveal a top layer of the entrained granules to create a fully exposed stone surface associated with the faux article, this further resulting in a scratch/mar, heat and light resistant article.

### CROSS-REFERENCE TO RELATED APPLICATIONS

The present application claims the priority of U.S. patent application Ser. No. 10/737,512, filed Dec. 16, 2003 and entitled Plastic Material with Decorative Attributes, and which in turn claims the priority of U.S. Provisional Patent Application Ser. No. 60/434,334, filed Dec. 17, 2002, of the same title.

### FIELD OF THE INVENTION

The present invention relates to decorative plastics for various architectural and aesthetic applications. The present invention also pertains to methods for producing plastic articles with decorative attributes.

### BACKGROUND OF THE INVENTION

In the plastics formulation and application industry, the area of plastics material with decorative attributes can be broadly categorized into three main categories: 1) materials employed in the solid surface industry; 2) spray process variants of plastics materials; and 3) various materials employed in applications such as plastic utility panels.

Solid surface panels have been in existence since their invention and introduction by DuPont in the 1960's. Examples of such materials are those commercially available under the trade name Corian®. Such materials are typically comprised of translucent thermoset resins with polygonal granules of crushed ingot suspended therein. The ingot material is made from monolithic castings of thermoset resin together with coloration and high loadings of a suitable mineral such as ATH (alumina trihydrate).

Examples of materials with an excellent stone-like appearance are relatively abundant when using thermoset materials and polygonal granules typical of the relevant art and as described above; solid surface materials such as the Corian materials as well as various materials such as those disclosed in various references such as U.S. Pat. No. 3,562,379 to Duggins or U.S, Pat. No. 4,085,246 to Buser, U.S. Pat. No. 4,544,584 to Ross, and U.S. Pat. No. 5,476,895 to Ghahary, and U.S. Pat. Nos. 5,628,949, 5,885,503, and 6,517,897 to Bordener, etc. While these materials exhibit excellent stone-like appearances they require the use of a high-clarity thermosetting materials as the base media resin. Each of these references teach materials that employ granules having an average aspect ratio of 1. Granules having such aspect ratios and configurations render only one or two small planes of the surface of the granule visible to the viewing surface of the sheet or resulting article. Therefore, typically less than 20% of the granule surface is visible from the viewing surface of the sheet or resulting article. The relatively small ratio of surface area to volume (the polygonal granules resemble spheres, which are by definition a geometric minimum of surface area to volume) is a key reason for the required use of high clarity thermoset media resin.

U.S. Pat. No. 6,548,157 to Ghahary is directed to a three layer laminate in which the outer layer comprises a filled crosslinked polyester layer, which has a stone-like appearance. The stone-like outer layer is generally a crosslinked unsaturated polyester resin in which the cross linking is achieved by copolymerization with an aromatic monomer which generally is styrene or at least contains styrene and which contains in addition to some inorganic filler, granules which themselves are crosslinked resin containing inorganic fillers and which have the same density as the matrix resin. The granules can be made from polyester resins, epoxy resins or acrylic resins.

U.S Pat. No. 5,476,895 to Ghahary discloses sprayable granite-like coating compositions comprising a polyester matrix resin, which contains a particulate crosslinked resin containing an inorganic filler and an additive, which equalizes the density of the particles to that of the matrix, distributed throughout the matrix. The particles are immiscible and visually differentiable and to large measure provide the granite-like appearance of the outer layer.

U.S Pat. No. 5,304,592 to Ghahary, teaches a coloring effect achieved with visibly differentiable plastic granules made from a combination of thermoset and thermoplastic resins that are isopycnic in density with the thermoplastic base resin in which they are distributed. These are discrete non-melting granules and are typical granules utilized in solid surface formulations in the industry. The granules are mixed into a thermoplastic base material of the small composition as the thermoplastic granules to provide a stone-like coloring effect for injection molding products such as flowerpots, computer housings, and the like.

The various Ghahary references fail to provide an effective method for producing panel-like material having a complex color system approaching an aesthetic three-dimensional visual effect in materials other than high-clarity resin media. Thus, the various Ghahary references teach a conventional, three-dimensional-appearing coloring system that relies upon prior art ingot-based granules. These granules are limiting in that they typically require a stratum thickness of 0.050 inch or more and are poorly suited for extrusion and thermoforming operations and create styrene emissions in the ingot manufacturing process itself. Further, these granules render any polymer system they are extruded into unrecyclable, and the roundish granules require the use of high clarity media resin.

It is believed that the substitutive step of replacing standard solid surface thermoset resin with thermoplastic media while utilizing a granule with an aspect ratio of 1 leaves a product with insufficient visible surface to the granule to yield an appearance of natural stone. The materials disclosed in Ghahary, Ross, Buser, and as currently commercially available from R.J. Marshall Company of Southfield, Mich. do not perform well in thermoplastic resin and yield extremely poor results in extrusion and thermoforming processes in general. Additionally, these materials are generally not conducive to thermoforming post-manufacturing processes due to brittleness and lack of a smooth finish upon thermoforming due to the rigid nature of the granules.

Typically, the pigmenting systems currently utilized in the solid surface industry employ visually differentiable decorative granules achieving an opaque color over a relatively thick dimension, i.e., the granules themselves have an aspect ratio of approximately 1 Use of an opaque or even semi-translucent base media resin allows only objects adjacent to or very near the surface to be seen. As used herein, “media resin” refers to the polymeric material in which the granules reside. Hence, the granules desired in the aforementioned references create a coloring system in which granules distant from the surface are only visible as tiny dots. Such visual appearance is an incomplete or poor representation of natural stone when observed in strata less than approximately 0.050″ thick. Furthermore, the ability to form a three-dimensional color effect with a thermoplastic or thermosetting base resin, while attempted previously, has not produced a process or material that addresses problems such as particle migration or settling over time. Additionally, the ability to create a thermoplastic sheet of appropriate physical quality and appearance has been problematic.

Spray process variants of solid surface materials are also known in the art and may be typified by the disclosure contained in U.S. Pat. Nos. 5,465,544 and 5,476,895 to Ghahary and Bordener, respectively. Such spray process application materials are still dependant on granule formulations such as those broadly disclosed previously. Examples of such granule formulations and manufacturing examples are disclosed variously in references such as U.S. Pat. No. 4,544,584 to Ross, and U.S Pat. No. 6,517,897 to Bordener.

Thermoset materials have other drawbacks as well. These include issues such as material brittleness that can impair material performance life and the like. Thermoset materials can also have relatively high material costs as well as require high processing costs to provide the desired product. Additionally, the thermosetting nature of the polymeric material severely limits thermoforming options. Finally thermoset materials of the nature contemplated and discussed are difficult to successfully form into an extremely thin veneer. Such thin veneer can be desirable in various applications.

Spray process solid surface materials are based upon standard solid surface chemistry with appropriate care taken in particle packing of the decorative granules to ensure the desired visual effect in a dimension much thinner than that achieved in prior solid surface materials as well as appropriate thixotropic, wetting and air release additives. Thicknesses on the order of 0.050 inch can be produced using spray application processes in contrast to the ½ inch thicknesses necessary in typical solid surface formulations. A difficulty in handling prior art granules in liquid resin media is the tendency of residual catalyst on the granule surface to catalyze the liquid resin media prematurely and the fact that the granules themselves are typically made from reacted thermoset resin and are therefore chemically un-reactive to effect any chemical bond in the (typically thermoset) media resin.

Typically in both spray process solid surface and non-spray process solid surface materials, granules utilized are polygonal, typically homogenous and substantially spherical in shape with an average aspect ratio of approximately 1. Such granules are relatively heavy with a specific gravity of 1.4 to 1.8. They are very rigid and sharp, and abrasive to process equipment. The granules are suspended in a translucent or clear thermoset media resin with the visible granules randomly distributed and oriented to create very pleasing appearance with a striking resemblance to natural stone. Much experience and skill relating to thixotropic additives, wetting and air dispersion agents is necessary to keep such heavy roundish granules in suspension.

The third category of decorative plastics, utility panels, may generally utilize thermoplastic materials to produce various uses and constructions. Typical panels range from 0.060″ to 0.75″ thick and are generally made to a planar nominal dimension such as four feet by eight feet in width and length or the like. The panel will typically be colored to produce a pleasing appearance to further whatever market application it may be intended for. Panels produced according to methods disclosed in the relevant art utilize coloration that is typically substantially homogeneous in nature, yielding a flat single color panel. Such materials may be marketed as “marine panels” or “utility panels” due to their robust physical properties, waterproof nature and plain appearance. Such opaque colored panels are rarely used for anything except dock trim, live well construction in boats, utility wall cladding, service station wall cladding, and other low economic value applications.

One example of a typical utility panel material composed of thermoplastic polymers is a coextruded material having a foamed center core. Examples of such materials are those marketed under the trade name SEABOARD®. Advantages of materials made via this process are greatly reduced cost compared to typical solid surface materials, relatively light-weight, and robust physical properties. Disadvantages of such thermoplastic materials exemplified by this product are flat, 2-dimensional coloration with no significant resemblance to natural stone.

Various injection-molded panels are also known. However, the resulting materials are again homogenous in construction. Since this is a thermoplastic material, no conventional solid surface granule can be easily employed due to concerns about cost, equipment wear, visibility of the granule in situ and relative bond strength between the granule and the plastic media resin, and the fact that the granules themselves will take up a considerable amount of space in any polymer sheet to be made.

Typically, in the decorative plastics industry, sheet material is often defined as having thicknesses greater than approximately 0.1 inch. With solid surface materials, available sheet thicknesses are at least ¼″ and most typically ½″ in order to provide sufficient strength and impact resistance for material handling and shipping. However, there is a growing desire to provide materials having thicknesses as low as 0.05 inches or less, as is typical of veneers in other building material markets. Such materials would provide significant advantages regarding reductions in overall material cost, shipping cost, weight reduction, thermoformability, and the like.

Early attempts to make thin veneers featuring a good stone-like appearance utilized two basic methodologies. The first was U.S. Pat. No. 5,628,949 to Bordener, originally commercialized under the trade name Korstone®. This is a spray-process solid surface which created a two-layer solid surface composite that is able to be molded into various shapes, etc. The second was a product marketed under the trade name SSV™, by the Ralph C. Wilson Co. of Temple, Texas. The process disclosed therein involved taking a solid surface formulation as generally described therein and extruding it into a thinner sheet of approximately 0.090″. The material produced by this process exhibited high percent breakage on production (thermoset materials are typically too brittle to be cast so thin) and very poor physical performance upon installation over a rigid substrates such as countertop applications. While The process disclosed in Bordener '949 was successful both physically and in the market, it did not address the broadest channel of the market—the pre-cast sheet. Bordener '949 (and other related patents by the same inventor) are best utilized to make pre-cast shaped articles, where the largest market segment in solid surface material is pre-cast sheet stock.

Additional references of note include such as U.S. Pat. No. 6,749,932, issued to Gould, and which teaches an article having a decorative visual surface appearance provided by a plastics composition which comprises a transparent or translucent plastics material having a colorant dispersed therein and which is characterized in that the colorant comprises a blend of discrete polymer particles, substantially all of which have a minimum dimension in the range of 5 to 100 micron and a maximum dimension of no more than 10 mm. The particles are typically constructed of a natural or synthetic organic polymer or glass, such a blend including particles from at least two distinct colors or shapes and a plastics composition containing 0.1 to 8 percent by weight of the blend of polymer particles based on the weight of the plastics composition.

The article in Gould can be made by a method which includes the steps of mixing together the blend and the plastics material or a precursor thereof and forming the article under conditions whereby the polymer particles in the colorant are not deformed to any substantial extent. The colored particles may also be provided in a color concentrate homogeneously mixed with a polymer or precursor thereof or a wax. The articles may also be molded, cast extruded, calendered or reinforced plastics articles, for example floor coverings.

Of note, Gould does not appear to be directed not does it provide any description or support for the concept of creating a very thin sheet of material, such as having a single, dual or triple layer construction which is coextruded, co-laminated or otherwise created. In particular, Gould does not permit this to occur since the granule composition identified, and which possesses a very poor aspect ratio of length times width relative to thickness, requires greater sheet thicknesses than which it typically desired for creating thin, easily transportable decorative laminates, these capable of easily being applied by an end user fabricator to such as a durable or rigid substratum material (e.g. particleboard or the like). The disclosure in Gould of avoiding any material breakdown of the entrained granules further is found to be undesirable in situations where a controlled degradation/fracture of the entrained organic and/or inorganic granules is desired to provide a more natural, lifelike appearance to a given glass/metallic/stone faux article.

U.S. Pat. No. 6,702,967, issued to Gould, teaches a process for preparing a decorative surface material having a decorative pattern and including a sheet, typically at least ⅜″ thick. A combination of domains of varying sizes and colors are defined by shading variations at the interfaces of adjoining domains, the decorative pattern being provided by a process in which a flowable thermosettable molding formulation having orientable particles mixed therein is divided into fragments which are mixed together. The mixture is then fed into a hot mold and pressure is applied to form the solid surface material.

U.S. Pat. No. 6,040,045, issued to Alfonso et al., teaches a plastic surfacing material having a bold and aesthetically pleasing appearance achieved by the use of TFR pigments, the latter of which are manufactured by orienting reflective flake pigments in a plastic substrate and grinding the substrate to a particulate material. PCT/WO 98/27131, to Riebel, teaches a fused multiparticle polymeric matrix material that includes fused discrete thermoplastic particles, wherein the particles have generally distinct boundaries once fused, and which emulates the aesthetic characteristics of stone (e.g., granite) used for countertops, tiles, flooring and the like.

The present invention addresses the weaknesses of the technologies disclosed variously in Gould '967, Alfonso '045, Bordener '949, Ross '584, the various Ghahary references and various commercialized solid surface materials to create a pre-cast sheet including lack of flexibility, cost, deficiencies in visual depth and degree of the stone-effect, thermoformability, scratch resistance and UV stability. Additionally, the relevant art materials disclosed require processing methods that have significant levels of cost and environmental impact.

In order to provide a pleasing aesthetic appearance, the plastic material is typically colored to customize the appearance of the resulting panel or article. Coloring systems can include media soluble granules, that act as a dye as described in U.S. Pat. No. 5,465,544 to Ghahary. This system is a thermoplastic coloration system that makes a “smeared” granule that will bleed color at specific temperatures to create a faux marble effect. It can also include granules that maintain their discrete visually differentiable characteristics when in situ in a resin media as in nearly all solid surface formulations and as intended with the present invention. Such panels are made with granules that do not melt or dissolve or otherwise loose their mechanical integrity so that the color will not destabilize during processing and create a panel with smears or color streaks.

Some of the hallmark problems of pror art methods of creating a three-dimensional color effect by means of positioning pre-hardened discrete granules in situ in any liquid plastic resin media include granule migration, exposure of the granule to the viewing surface, and compatibility of the granules with the manufacturing process. In a thermoset manufacturing processes, these manufacturing problems may be addressed with tight process controls pertaining to such properties as viscosity, mold cavity fill rates, and flow control. Furthermore specialized chemistry is typically required utilizing materials such as thixotropic, buoyancy and molecular stabilizing additives such as fumed silica, and specialized wetting, and coupling agents. Such process controls add significantly to the cost of a product, both by direct ingredient cost, and also in specialized equipment costs and the cost of skilled labor to run and control such processes. Production of suitable panel stock utilizing prior art granules with an average aspect ratio of 1 often requires abrasive planning of a at least one panel surface to allow a good view of the three-dimensional granules, and to permit a large enough plane (preferably to bisect an individual granule to create a hemi-granule) of the polygonal granule to be clearly visible. This planing typically removes from 1/16″ to 3/16″ material off one plane of the entire sheet, which in the case of a veneer material equates to a 50% material loss. Further, this planing is typically most successful with more expensive thermoset-based resin chemistry. Given characteristics in planing techniques, thermoset-based resin formulations have been preferred to withstand the necessary brittleness and heat resistance required for abrasive planning so that the panel itself does not melt during this energy-intensive process. Another difficulty in such systems is the relative incompatibility of traditional rigid granules with respect to their respective coefficients of thermal expansion and contraction and their relative thickness to a thin sheet since the granules have an average aspect ratio of 1 and their abrasive nature to typical high mineral content and available low cost thermoplastic extrusion processes.

There exists a long-felt need for plastic materials having satisfactory aesthetic appearances, especially those with a visual stone-like appearance. This has been difficult to achieve in an efficient and economical manner particularly in situations where a thin veneer is required. Thus, it is highly desirable to provide a plastic material having high aesthetic value. It is also desirable, in certain instances, to provide a thermoplastic or thermoset panel having high aesthetic value color effects. While this has been accomplished to a certain extent with prior art thermoset resins in thick panel material, plastic materials which can be formed into various thin veneer applications such as utility panels thus produced tend to exhibit disappointing performance with respect to basic physical properties necessary to allow the material to be made into thin sheets or veneers having necessary impact resistance and tensile strength resulting in a brittle sheet material. This appearance has been difficult to achieve with commodity grade material such as thermoplastic resins, especially olefins and the like It is also desirable to achieve special appearances in plastics while reducing or eliminating emissions of such processes and to improve the recyclable nature of such materials.

It is a goal of the present invention to provide an additive system employing granules that can both tolerate and create an additional variation in plastics formulations during processing but one that does not necessarily involve and melting/dissolving or any color instability in the granule. It is an additional goal of the present invention to provide granules that are constructed and confirgured to control the amount of breakdown and resultant smaller granule promulgation during processing thereby controlling the aesthetic effect exhibited by the resultant article or sheet. This may be achieved by varying the percent content of granules made from rigid (mineral) and flexible thermoplastic materials including but not limited to cellophane and biopolymer materials.

Thus it would be desirable to provide a coloring system and associated thermoplastic-based material that addresses one or more of these shortcomings. Thus, it would also be desirable to provide a coloring system for plastic materials, a plastic material and a resulting utility panel incorporating such plastic material system that would match the traditional three-dimensional coloring systems found in thick panel material such as DuPont CORIAN®. Additionally, it is desirable to have a coloring system and plastic material capable of being processed using equipment such as existing extrusion and injection equipment in a manner that requires minimal equipment modification. It is also desirable that the plastic material exhibit three-dimensional aesthetic effect with reduced pigment loading requirements and improved color control of the materials employed. It is also desirable that the plastic material be thermoformable as desired or required, with smooth surface characteristics after thermoforming and exhibit minimal material brittleness. It is also desirable that the foregoing be accomplished utilizing lower cost, more flexible thermoplastic-based formulations. Further, it is desirable that the material formulation be producible in a very thin veneer that retains the full aesthetic affect. Further still it is desirable that the finished product was itself, recyclable to be re-cast as first-quality product. Still further, it is desirable to create a aesthetic appearance for plastics of all kinds with a material that can be made in an emissions-free process. Finally, It is also desirable to provide a process that creates a plastic material with a stone-like color effect for use in a wide variety of applications including, but not limited to, traditional solid surface and spray-able solid surface applications.

### SUMMARY OF THE INVENTION

The present invention discloses a method for preparing a polymeric article such as, but not limited to, a polymeric utility panel having three-dimensional aesthetic color characteristics. The preparation method includes the steps of mixing the granule-based coloring system described herein into a suitable polymeric base material. The polymeric base material with the admixed visually differentiable granule material contained therein is formed into the desired structure, such as by coextruding, co-laminating, injection molding, bulk molding, rolling and curtain walling processes, castable processes, thermoforming or the like, a thin planar sheet structure. The resulting polymeric article, such as a polymeric utility panel, possesses aesthetic characteristics such as the appearance of natural stone or glass. The polymeric article may also exhibit aesthetic characteristic which mimic attributes metal effects including, but not limited to, copper, brass, cast iron and the like.

In a particularly preferred application, an applied hydraulic force, such as which may be applied along a planar direction and in cooperation with a separate linear directed hydraulic force associated with a sheet article formation step, will cause the associated granules, these typically comprising high aspect granules and which are defined as including both organic and/or inorganic entrained particles exhibiting an average maximum length or width at least twice that of a respective thickness (aspect ratio of two) or greater. In further preferred applications, the average aspect ratio of the granules can be much greater, such as by a factor of six or more.

Among the unique features of the hydraulic applied pressure gradient across the fluidic resin medium is the ability to align the high aspect ratio granules in a substantially parallel and evenly dispersed fashion. The application of the hydraulic pressure, from regardless the direction, will further cause the granules to flow in a substantially laminar direction during the formation of the sheet (by whichever preferred process is selected) and, in a further application, in a combined parallel and/or tangential fashion in the instance of forming a three dimensional article exhibiting a curved (substantially non-planar) form, such as a sink bowl or the like.

A further variant of the present method employs a tensile force application to a semi-molten state, semi-hardened sheet, and in order to properly align entrained and high aspect ratio granule. In contrast to the hydraulic forces applied substantially along a planar (linear) direction relative to the viewing surface of the sheet, the tensile generation employs “stretching” the molten sheet to the limited degree necessary to substantially horizontally realign the aspect ratio granules, and without inflicting any damaging the resultant end product.

The granules themselves may include thin flakes or dry powder. They may be made from one of two basic materials; the first is cleaved minerals such as mica, which is opaquely coated to create a color, the second is shredded (or die cut) plastic film. The film may be coated on its surfaces (esp. when using clear film), only on one surface, or homogenously. Both materials are typically less than 0.010″ thick and are substantially indistinguishable from another when cast in into plastic resin.

The present method further contemplates the “roughening” of the surface of the associated article created, this being caused by the removal of a selected thickness of material to reveal a top layer of the entrained granules (such as to a depth of 0.001 ″ to 0.01″ or from 1 mil to 10 mils). The benefit of this post production step is to create a fully exposed stone surface associated with the faux article created, this further resulting in a scratch/mar, heat and light resistant article providing an improved appearance, especially if uncolored raw granules are blended in with a colored granules or an otherwise colorized/veined substratum.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of a utility panel assembly integrating a polymeric sheet as disclosed herein;

FIG. 2 is a cross-sectional view of a representative mold of the type which can be utilized to manufacture a sink in accord with the present invention;

FIG. 3 is a depiction of the mold if FIG. 2 showing a body of solid surface material of the present invention disposed therein;

FIG. 4 is a schematic depiction of a first stage in a compression molding process employing the mold and solid surface coating of FIG. 3 together with a top compression member;

FIG. 5 is a depiction of a further stage in the compression molding process shown in FIG. 4 wherein the top compression member is closed;

FIG. 6 is a depiction of a further stage in the compression molding process shown in FIG. 5, wherein the top compression member is removed;

FIG. 7 is a cross-sectional view of a sink as produced in the compression molding process of FIGS. 4-6 prior to final finishing;

FIG. 8 is a cross-sectional view of the molded sink after final processing;

FIG. 9 is an environmental view of a combined resin flowable and pressure application process for creating an article exhibiting substantially parallel oriented granules according to a further preferred embodiment of the present invention;

FIG. 10 is an enlarged partial view of a dual layer article created according to the embodiment disclosed in FIG. 9;

FIG. 11 is an end plan view of a formed article, such as shown in FIG. 10, and further illustrating the parallel oriented nature of the upper layer entrained aspect ratio granules, as well as exhibiting an optional surface/protective coat;

FIG. 12 is a schematic illustration of the dual force application applied to a substantially planar article to create the substantially parallel oriented granules according to the present invention;

FIG. 13 is an illustration of a farther, substantially non-parallel, article produced according to the present method;

FIG. 14 is an illustration of post production a scraping/abrading process step intended to highlight the scratch/mar, heat and light resistance of the article and to provide an improved appearance;

FIG. 15 is an illustration of a further variant of the present method and which employs a tensile force application to a molten state, semi-hardened sheet and in order to properly align entrained and high aspect ratio granules; and

FIG. 16 is a side plan view of the tensile force applied sheet of FIG. 15, and illustrating the substantially aligning nature of the entrained aspect ratio granules resulting from the hydraulic influenced forces applied in a substantially linear direction to the molten sheet.

### DETAILED DESCRIPTION OF THE PREFERRED EMBODIMENTS

The present disclosure is directed to a polymeric resin material with additives that may be formed into a sheet or other polymeric article. The polymeric resin material as disclosed herein has at least some degree of translucency or semitranslucency and the additives include visually differentiable granules of a type and nature defined herein contained in situ in a base polymeric media resin. As defined herein, the term “translucency” is taken to mean the ability to permit passage of at least some visible light. The term “visually differentiable” is taken to mean the ability to visually distinguish or discern differences in particles contained within the polymeric sheet or media resin. Typically, visually differentiability includes at least some distinction in color characteristics of associated particles, either inherent or imparted due to residence in the polymeric media resin.

The polymeric media resin may be from any combination of or either thermoplastic or thermosetting polymeric material as defined subsequently. The visually differentiable granules are integrated into the polymeric media resin in a manner that provides the desired aesthetic characteristics sought. The visually differentiable granules may further be either polymeric or mineral-based or combinations thereof. The visually differentiable granules are composed of at least a first and a second color groups, each color group having a pigment shade. The pigment shades of the first and second color groups differ from one another, Additionally, the visually differentiable granules each possess a planar dimension, a thickness and an aspect ratio defined between the planar dimension and the thickness. The aspect ratio for the visually differentiable granules is at least 2 with the granules having a maximum thickness of no more than 0.02 inches.

Also disclosed is an additive system for use in a polymeric formulation that includes a plurality of visually differentiable granules such as those defined previously and a method for producing articles having decorative aspects utilizing the granules therein. The articles can be produced by any suitable methods including, but not limited to, extrusion, injection molding, casting, thermoforming, spray application and the like. The polymeric articles so produced can be of any suitable intermediate or end-use configuration. In situations where the polymeric article or sheet is configured to have food contact applications, it is contemplated that the polymeric base resin, granules and all ancillary additives will be materials which are classified as “Generally Recognized as Safe” for food contact applications, and have been manufactured according to compliance with FDA# CFR21-175.300 and CFR21-178.3297.

For purposes of illustration, the present disclosure will be discussed in terms of a polymeric sheet. It is to be understood that the polymeric sheet can be integrated into various configurations and assemblies as desired or required. As depicted in FIG. 1, the polymeric sheet 10 may be at least one component in a polymeric utility panel 12. Typically, the sheet 10 comprises a polymeric base resin 14 and visually differentiable granules blended from at least two color groups having visibly differentially, substantially opaque color hues. The aesthetic effect of the overall polymeric sheet 10 can be governed by at least one of the following attributes: opacity of the base resin, aspect ratio of the individual visually differentiable granules, and particle size-distribution of the greatest dimension of the visually differentiable particles as well as the use of any dispersion dyes. In situations where the polymeric sheet is part of an assembly having a backing element, the aesthetic effect can also be governed by the opacity of the backing sheet. It has been found, quite unexpectedly, that careful control of one or more of these characteristics can achieve true three-dimensional appearance bearing a striking resemblance to commercially successful products such as that disclosed in the Bordener '949 patent and in commercially available materials such as Dupont Corian. All this is achieved within a significantly thinner stratum thickness than accomplished with previous formulations and compositions.

In the process and article disclosed herein, it is contemplated that the polymeric sheet can have a thickness between 0.003 and 1 inch. The polymeric sheet 10 will have at least 3 layers of granules contained therein with stratum layers of between 5 and 10 being possible.

Where desired or required, the polymeric utility panel 12 can include a back zone 18 of highly opaque polymeric material which can be continuously bonded or formed on one side of the polymeric sheet 10 in a manner to permit the material to be laminated to a suitable structural substrate 20 such as particle board, gypsum, etc., in a manner which renders the substrate and any associated adhesives 22 invisible upon conventional viewing. Corona treatment will usually aid in this interlayer bonding and for the ultimate panel back so that it may be bonded to other building materials such as particle board and the like. The polymeric utility panel 12 as disclosed herein may also include a continuous surface protective layer 24 continuously attached to an outer face of the sheet to provide additional protection against gauging, scratches, overall abrasion, and the like. It is also contemplated that the continuous surface layer 24 can be formulated to include materials such as UV stabilizers and the like as desired or required.

The visually differentiable granules 16, can be composed of various materials. A portion of the visually differentiable granules 16, may be plastic materials formed from films, powders, or wafers, which may be cut, or shredded into small flakes. These granules can be sized and blended within certain parameters of size and color in a manner which, when incorporated into a polymeric material, will create a three-dimensional visual image having a stone or faux-stone appearance. Key parameters for granule material suitability include, but need not be limited to, at least one of: (1) mechanical stability of the resulting panel, (2) colorfastness in processing (heat and chemical tolerance), (3) overall tint strength (opacity) of the granule, and (4) aspect ratio of the granule from its mean large (planar) dimension to its thickness, and (5) mechanical robustness of the granule in process and post process (e.g. thermoforming) operations. The visually differentiable granules6, are of a suitable size and configuration to permit casting or extrusion into a sheet of approximately 0.5 to 0.01 inch thicknesses in a manner which will permit multiple strata of the visually differentiable granules 16 to be disposed therein.

The materials used in the visually differentiable granules may be those possessing initial flexibility sufficient to prevent complete embrittlement, while avoiding unwanted promulgation of smaller granules during any succeeding agitation or processing step, such as occurring during a subsequent manufacturing process These agitation and/or processing steps may include the processing steps indicated previously as well as any-compounding, agitation steps, and pressing, forming, spraying, mixing, which may occur as a result of formation of the polymeric article or its precursors. The granule material of choice will be one that is chemically compatible with the polymeric resin matrix used in the sheet or resulting product. Compatibility, as defmed herein includes characteristics such as good bonding between materials, chemical stability and the like. The granule material will also possess appropriate heat stability to withstand manufacturing processing temperatures such that the essential intactness of the visually differentiable granule(s) is maintained. As defined herein, “essential intactness” of visually differentiable granules is taken to mean that the particles will retain suitable form and performance at the processing temperature employed. Thus, some softening or molding of the granules can be tolerated provided that the granules remain in essentially intact form and arrive in the finished panel or product within certain size distribution parameters. Thus it is contemplated that the degree of softening will be less than that necessary to achieve the aesthetic effect accomplished in materials such as those disclosed in U.S. Pat. Nos. 5,465,544, 5,304,592, and 5,476,895 to Ghahary.

Additionally, the granules employed herein have an aspect ratio of at least two, with aspect ratios of at least 5 being preferred and aspect ratios greater than about 7 being most preferred. In contrast, both Ghahary '592 and '895 teach the use polygonal granules with an average aspect ratio of approximately 1. It is contemplated that the visually differentiable granules utilized herein will include at least one pronounced face. The granules can have flake-like structures that can form into cup-like shapes that are contained within the base polymeric resin. Such cup-like shapes can orient in an essentially random fashion to provide shadows and inclusions to create further visual depth and diversity.

It is contemplated that the materials employed in the visually differentiable granules will exhibit appropriate heat stability temperature relative to the associated sheet manufacturing process. Similarly, it is contemplated that any pigment(s) and or additives employed within or on the granule will exhibit suitable heat stability.

The material employed in the visually differentiable granules is, preferably, configured to prevent or minimize breakage of material during processing. While a certain degree of breakage can be tolerated, it has been found that the breakage and promulgation of smaller particles from the main visually differentiable particles employed in the matrix, in certain situations, can act as a standard pigment or dye material thereby lessening the overall translucency and beauty of the resulting product. Additionally, where excessive breakage is encountered, it has been found that undesirable color shifts may occur. Thus, while breakage and associated pigment promulgation does not preclude the production of successful material, it has been found that such promulgation should occur, if at all, in a predictable and controllable nature that can be adjusted for and adapted to prior to and during manufacture when the process disclosed herein is employed.

Suitable granule materials include, but are not limited to, various polymeric materials such as polyester and acrylic thermoplastics and various minerals. Examples of polymeric materials include, but are not limited to, suitable colored polymeric films. Suitable films are generally colored during the film formation stage. Suitable films are thin gauge film (16-30 microns, for example) and can be composed of suitable high melt temperature polymer(s). Non-limiting examples of polymers include various cellophanes such as those commercially available from sources such as UCB Film of Atlanta, Ga., biopolymers (including films produced with regenerated cellulose) as available in ground and sized from All Plastics, Inc. of Waterford Mich., as well as materials colored with organic pigments, and then sized. Examples of other polymeric materials include, but are not limited to thermoplastics such as ABS (polymers produced by polymerizing acrylonitrile, butadiene and styrene), ACS (polymers of polymerized acrylonitrile, chlorinated polyethylene and styrene), olefin-modified styrene-acrylonitrile, acetal homopolymer, acetal copolymer, ionomers, nitrile resins, phenylene-based resins, polyamine-imide, modified polyphenylene ether, polybutylene, polycarbonate, aromatic polyester, thermoplastic polyester (e.g., polybutylene terephthalate, polytetramethylene terephthalate or polyethylene terephthalate), polypropylene, polyetheretherketone, polyetherimide, ethylene acid copolymer, ethylene-ethyl acrylate, ethylene-methyl acrylate, ethylene-vinyl acetate, polyimide, polymethylpentene, polyphenylene sulfide, nylon, acrylic, polyethylene, etc. and combinations thereof. Thermoset plastics that may be employed include plastics requiring a chemical additive to cause a state conversion of the plastic from liquid to solid. Such thermoset plastics include, but are not limited to, allyl esters, aminoresins, furan polymers, phenolic resins, unsaturated alkyd polyester, unsaturated polyester, epoxies and melamine Suitable acrylic materials are discussed in the Ghahary references mentioned previously, the specifications of which are incorporated by reference herein. The most common techniques for sizing are roll cutting; the resultant product can be a symmetrical shape (typically squares, rectangles or hexagons) with single particle size. Another method is random cutting or grinding; which produces asymmetrical particles in a varying particle size distribution. This distribution can be controlled by sieving to provide more consistent size distribution and associated visual appearance. Pneumatic obliteration is also envisioned to break down film into random shapes

Examples of suitable minerals include, but are not limited to, silicates and micas. Suitable mineral materials such as silicates and micas may be treated to comprise two or three layers of surface treatments. An illustrative material may include a first treatment layer comprising a surfactant designed to compatibilize the mineral surface with the coloring medium. This treatment may immediately react with the mineral in the liquid phase or may be dried onto the mineral surface. A second layer may include a color treatment applied to the prepared surface of the mineral. If the first treatment is completed in the liquid phase, the color treatment may then be incorporated in the same step. Lastly some type of encapsulation solution can applied to resultant colored mineral. This last solution will usually fully cross-link with/around the earlier treatments and is usually designed to render the surface inert, but may also act as a binder agent with the plastic media that the granule will be placed within (e.g. and acrylic-based formulation of encapsulation to bond with unsaturated polyester gel coat.).

Various polymeric materials may also be used as the granule material one suitable class of polymers are the acrylics. Examples of suitable acrylics include polymers and copolymers belonging to the acrylate and methacrylate resin families as well as acrylate and/or methacrylate esters. It is contemplated that such materials may be used singularly or in combination, as well as functionally substituted derivatives.

Typically, the alkyl groups of acrylic monomers may range from 1 to 18 carbon atoms. Preferably, such monomers range from 1 to 4 carbon atoms in length. Suitable acrylic monomers include, but are not limited to, materials such as methyl and ethyl acrylates and methacrylates, n-propyl and isopropyl acrylates and methacrylates; n-butyl 2-butyl, isobutyl, T-butyl acrylates and methacrylates; 2-ethylhexal acrylate and methacrylate; cyclohexal acrylate and methacrylate; ω-hydroxyl alkyl acrylates and methacrylates; n-(t-butyl) amino ethyl acrylate and methacrylate, and the like. Unsaturated monomers useful in the subject invention include bis-(β chloroethyl) vinyl phosphonate; styrene, vinyl acetate, acrylonitrile, methacrylonitrile, acrylic and methacrylic acid; 2-vinyl and 4-vinyl pyridines; maleic acid, maleic anhydride and esters of maleic acid; acrylamide and methacrylamide; itaconic acid, itaconic anhydride and esters of itaconic acid and multifinctional monomers for cross-linking purposes such as unsaturated polyesters; alkaline diacrylates and methacrylates; alkyl acrylate and methacrylate; n-hydroxymethylacrylamide and N-hydroxymethacrylamid; N,N′-methylene diacrylamid and dimethylacrylamid; glycidyl acrylate and methacrylate; diallylphthalate; di-vinyl benzene; di-vinyl toluene; trimethanol propane, triacrylate and trimethylacrylate; pentaerythritol tetraacrylate and tetramethacrylate; triallyl citrate and tryallyl cyanurate.

Commercially available examples of such materials include materials available under the trade names MYLAR® as well as materials such as cellophane and celluloid as well as various materials such as polybutylene teraphthalate, polyethylene teraphthlate, micas and certain biopolymers and the like. It is also contemplated that materials such as cellophane and various other thermoplastic films can be employed. Other examples of the visually differentiable particles include materials such as aluminum foil, cellophane, various thermoplastic films, and vegetable starch.

Visually discernable granules may also be prepared from various biopolymers. As used herein, the term “biopolymer” is defined as polymeric materials derived, at least in part, from plant starch or starches. Suitable biopolymeric materials are resins produced from organic natural materials that provides a chemical hydrocarbon strand or chain similar to those found in thermoplastics. It is contemplated that the biopolymeric resins may contain limited concentrations of petroleum by-products in significantly lower concentrations than typically found in standard thermoplastic materials. Suitable materials may include, but are not limited to, those, used in food packaging, wrapping and bio-degradable applications. Suitable materials can be produced by various processes including processes producing regenerated cellulose or rayon derived from various sources including wood pulp, cotton and the like, as well as algenate materials derived from seaweed and materials derived from vegetable protein such as casein.

Broadly construed, such materials can be produced from reacting various naturally occurring polysaccharides and/or proteins in a suitable coagulating medium. One coagulating medium suitable for cellulose derived from cotton, wood, vegetable fibers and the like is a slurry of alcohols and natural cellulose fibers dissolved in a water bath to solubilize the fibers followed by the removal of the water to achieve cross linking. Biopolymers suitable for use in granules as disclosed include but are not to be construed as limited to those commercially available under the trade name Deco-Spex from All Plastics, Inc. of Waterford Michigan.

When producing nondispersing granules from film, suitable materials will typically contain a fully cross-linked polymer chain that is not readily degradable. In biopolymer materials, the films used are produced by the dissolution of cellulose into a slurry, that is then extruded through a thin slot and ultimately forms a clear or transparent film of fully regenerated cellulose. Where the slurry has a pH of no less than 7 but no greater than 12, the aqueous medium fully dissolves the cellulose. Where the cellulose contains lignin or starch, such materials are completely soluble in the aforementioned slurry when the slurry is heated. The resultant slurry is then extruded, poured or in some way filtered through a thin slot to form a film in the drying and regeneration phase(s) of the production cycle. The resultant material can be dispensed into an acid bath of dimethylethanolamine causing the regeneration of the cellulose. The material is then washed or treated with a finish, rolled onto spools, and the slurry is then dispensed onto heated rollers with a temperature of at least 175° to 230° degrees F., causing the slurry to dry into a film, sheets, or flakes of regenerated cellulose.

Whereas the resultant final product is a clear film with a content of 90-95% cellulose and less than 5% moisture and where this moisture should not contain glycols, polycols, or other complex alcohols and the surface of the final sheet is inert.

As indicated previously the granule aspect ratio is one that will permit contouring of the visually differentiable granules during processing. Granules with high aspect ratios (i.e. top to bottom surfaces larger than side surfaces) are preferred. Typically particles produced and utilized will have an aspect ratio greater than 2:1 are preferred with aspect ratios greater than 5:1 being more preferred and aspect ratios greater than 7:1 being most preferred. Aspect ratios between 2:1 and 40:1 can be successfully employed. However, the upper limit for the granule may be defined by the opacity of the granule itself. Thus, the aspect ratio can be as high as can be achieved without compromising granule or performance of the associated polymeric resin matrix. The resultant effect strikes an excellent compromise between hiding and overall tint strength.

Mineral-based, visually differentiable granules such as ATH and calcium carbonate and the like inherently possess three measurable dimensions. This can produce an appearance of depth but must rely almost solely on packing of the granules to create opacity and the desired effect of a stone-like appearance. In such situations, it is contemplated that mineral-based granules having aspect ratios ranging as high as 15:1 to 22:1, as would be achieved with mica or talc, can be successfully utilized to increase the population of particles visible at or part surface as well as achieve greater opacity at greatly reduced material loadings. Examples of suitable high aspect ratio minerals are available from various commercial sources including All Plastics, Inc. of Waterford Michigan. At such aspect ratio values, it is also contemplated that the resulting utility panel can be produced at stratum thickness ranges such as between 0.007″ and 0.030″ with acceptable flexural and impact strength.

Polymeric film-based visually differentiable particles are contemplated to have film thicknesses ranging from 0.1 to 20 mils with ranges between 0.5 and 4 being preferred. Materials can be die cut with precision spaced die wheels if desired or required. Controlling the film thickness and cutting distances on the wheel allow for tailored aspect ratios to be created and maintained much easier than with mica or other mineral based colorants. Aspect ratios ranging from 2:1 to 40:1 can be employed, with aspect ratios between 5:1 to 40:1 being more preferred, and 5:1 and 30:1 being most preferred. It is contemplated that use of materials having larger aspect ratios will be limited due to the increased opportunity for bending, folding, and creasing of the material, which, in excessive amounts, can be detected visually as undesirable. However, in situations where such phenomena can be mitigated, or addressed, it is contemplated that greater aspect ratios may be utilized.

An undesirable visual effect associated with commercially available die cut film is its symmetrical appearance. Creating “stone-effect” appearances seems more natural with asymmetrical particle materials. Randomly crushed plastic film-based granules in suitable polymeric formulations are available from All Plastics, Inc. of Waterford Michigan. It is also contemplated that the materials produced and employed will be color stable at the processing temperature of the base resin employed. Without being bound to any theory, it is believed that good color stability contributes to batch-to-batch consistency as well as to general performance characteristics and excellent chemical resistance in various formulations.

Since these materials are designed not to disperse, the ability to retain the color veneer on the surface of the mineral is paramount. If the color veneer is stripped or migrates from the surface, it can cause discoloration and streaking, referred to as “bleeding” by those practicing the art. The color veneer can be successfully cross-linked to surface of silicate materials such as silica, calcium carbonate, or mica, through dying or pigmenting the surface of the mineral, especially in the presence of a binder agent such as an epoxy or other suitable material. Dyed materials have high tinting strength, but without adequate encapsulation, the dye can be compromised either by solvent interaction or polymer bonding, which can cause the dye to migrate from the surface of the mineral.

Bonding a pigment to the surface of the granule can be done by commingling organic pigments with covalent binding agents that cross-link to the surface of the mineral. The resultant material is further encapsulated with a suitable resin solution. Suitable encapsulation materials may include, but are not limited to, epoxy-based materials. The surface of the material can be rendered completely inert to minimize reactivity to other polymers as desired or required. It is also contemplated that the granule surface may be formulated to react and bond with the media resin where appropriate. This material offers high UV resistance, FDA compliance for food contact applications.

If granules and associated base resin matrix are going to be processed in thermoplastics equipment such as an extruder or injection molder, then the pigments selected are preferably thermally stable to at least 25° Fahrenheit higher than the processing temperature of the polymer. Thermal stability can be particularly important when utilizing colors such as red and yellow where failure manifests itself as random changes in hue. These colors are also used in the manufacturing of other basic colors like browns and greens. The material requires higher temperature stability than processing temperatures to compensate for frictional heat generated or flocculation between temperature settings and actual internal temperatures or spikes in temperatures from zone to zone.

In visually differentiable granules prepared from polymers, veneer colored films can be created by multipass color systems similar to ones used in foil stamping industry. A tie coat can be applied to the film surface followed by a treatment of color with an optional finish coat for gloss if required. This multilayered treatment would not exceed 20 microns in thickness to keep the coating from cracking or being mechanically stripped from the film's surface.

Thermal stability for polymer films pertains to both the film and the colors used to opacify the film. For the same reasons as colored minerals, the colorants used to opacify the film are preferably thermally stable to at least 25° Fahrenheit higher than the processing temperature of the polymer. If the polymer is thermoplastic, it is preferred that the material should have a melting point at least 75° Fahrenheit higher than the processing temperature of the polymer. As the film is subjected to increasing temperatures, the film can begin to curl and ultimately melt causing visual anomalies such as voids in color and streaking.

For good visual effect, it is preferred that not more than 20 percent of the granules possess a size smaller than that which will create excess opacity in the base polymeric resin sheet. Typically, this size is less than 0.009″ in mean diameter, with sizes less than 0.004″ in any planar dimension being preferred. It is contemplated that small size visually differentiable granules is considered exclusive of materials such as color-neutral fillers and the like. The small visually differentiable granule component is of a size and nature that minimizes phenomena such as color shifts. Typically, granule stock will be from 0.001 to 0.004″ thick so that the granule maintains maximal flexibility to avoid undesired color shifts due to handling of the granule in manufacturing and final processing. It is contemplated that thinner granular material is preferred in many situations as thinner granular material tends to fold and contract as a result of the energy imparted from the manufacturing process employed rather than breaking and promulgating into a powder and create undesirable opacity and/or color instability.

The visually differentiable granules can be substantially opaque, semitranslucent, or transparent, or combinations thereof, as desired or required. Additionally, the visually differentiable granules can be employed with other pigmenting systems as desired or required. Examples of such pigmenting systems include, but are not limited to, soluble dyes, common resin pigments, interference pigments, and coarse-grained pigment systems including such “ingot-based” systems as discussed herein. As used herein, the term “soluble dyes” refers to materials that typically have diameters less than 10 nanometers. “Common resin pigments” as used herein include particles that typically are between 0.9 and 1.2 microns in diameter. “Interference pigments” typically contain particles having diameters between 10 and 150 microns, while “coarse-grade pigment systems” have diameters that typically range between 0.002″ and 0.1 inch.

As indicated previously, the visually differentiable granules can be composed of at least two color hues. The combination of differing hues can create different color effects in formulation as desired or required.

In the various polymeric articles such as the utility panel disclosed herein, the visually differentiable granules can be present in a size distribution array that maximizes the three-dimensional and color effects in the resulting polymeric panel. In the decorative panel and polymeric material as disclosed herein, it is contemplated that between 0 and 20 percent of the visually differentiable polymeric granules will have a mean average diameter or width less than about 0.004″ to 0.009″. The visually differentiable polymeric granules will be composed of between about 7 and about 30 percent having a mean average diameter or width between about 0.006 and about 0.01 inches. The visually differentiable granules also include a third size distribution that ranges from 0.01″ to 0.1″ opacity, or approximately 0.0275 inches. Typically, these large size granules are present in an amount between about 30 and about 70 percent.

In preparing a mixture of visually differentiable granules, it is contemplated that small sized granules as defined herein can include a size population between about 0.002″ and about 0.004″, which constitutes between 0 and 60 percent of the small granule size category. The visually differentiable granules having an average mean diameter between 0.004″ and 0.006″ will constitute between about 20 percent and about 90 percent of the small granule population, with granules in the two aforementioned average mean diameter sizes, each constituting approximately 50 percent of the small granules size material.

The visually differentiable granules in the intermediate size category can preferably be of two average size distributions. It is contemplated that between 10 percent and 40 percent of the intermediate size granules will have an average size between about 0.006″ and about 0.01″. The balance will have an average granule size between about 0.01″ and about 0.1″.

One representative size distribution formula is set forth in Table 1. This size distribution is to be considered illustrative and is not to be construed as limitative of the size distributions contemplated herein. It is contemplated that variations in size distribution can be accommodated within the disclosure set forth herein.

TABLE I

| | | |
|---|---|---|
| Size A | .0275″-.0165″ | =21% |
| Size B | .0165″-.01″ | =40% |
| Size C | .01″-.007″ | =17% |
| Size D | .007″-.006″ | =7% |
| Size E | .006″-.004″ | =7% |
| Size F | Less than .004″ | =7% |

It is to be understood that the formula set forth in Table 1 can be modified as desired or required within the parameters set forth herein. One such modification can include the incorporation of large granules to create a large granule effect. Incorporation of large granules can create various textural effects. When large granules are employed, the amount of visually differentiable granules incorporated in the polymeric matrix resin can be reduced by the percentage of large granules added. Where variegated color effect is desired, the larger granules themselves can be enhanced by using nonhomogeneously colored feedstock. Where substitutions are desired or required, any size granule can be removed or modified. However, it is preferred that granules smaller than approximately 0.02″ generally can be substituted for or removed.

Non-limiting examples of possible size distributions utilizing colored minerals are set forth in Table II. The target distribution as described in Column B is illustrative for distributions processed with low mechanical sheer, such as casting, spray-up, or low-speed mixing. The distribution set forth in Column C is desirable for applications with high sheer forces or intense mixing. This distribution compensates for change in granule size distribution during processing in such applications as thermoplastic extrusion, compounding, and injection molding, most of which requires the material to endure two sheer histories during the production of the final materials.

TABLE II

| Column A | Column B | Column C |
|---|---|---|
| U.S. Mesh | % Retained | % Retained |
| 40 | 20 | 50 |
| 60 | 40 | 15 |
| 80 | 17 | 15 |
| 100 | 7 | 10 |
| 140 | 8 | 3 |
| 170 | 3 | 3 |
| −170 | 5 | 4 |

Directly related to granule size distribution is the ability of the material to retain its shape during processing. This can be accomplished with granules dense enough or with flexural modulus sufficient to withstand mechanical sheer during processing. Since many minerals lack in flexural modulus, dense minerals such as calcium carbonate, silica, or mica are most viable. However, hardness and abrasion must be reduced to protect form high tool wear, leaving mica the highest candidate.

A non-limiting example utilizing colored polymeric film as a visually differentiable granular material is outlined in Table III. Because colored polymer has the ability to retain full particle integrity, the target distribution for this material follows the originally prescribed distribution as described in Column B. This distribution remains unchanged whether processed as describe in mechanical sheer processes. Most films have sufficient flexural modulus to endure processing sheer forces without degradation. This is true even in situations requiring the material to endure two sheer histories during the production of the final parts. Film currently used by those in the art include polyester, cellophane, Mylar™ and aluminum foils.

TABLE III

| Column A | Column B |
|---|---|
| U.S. Mesh | % Retained |
| 40 | 21 |
| 60 | 39 |
| 80 | 17 |
| 100 | 7 |
| 140 | 8 |
| 170 | 3 |
| −170 | 5 |

Polymer film particle integrity heightens the importance of proper size distribution in order to create opacity while establishing a “3 dimensional (3-D)” appearance. The finer the size distribution, the more opacity created. The resulting opacity masks the larger granules and dilutes the macro appearance of 3-D particles.

Since these particles have the ability to retain their original shape during processing, their mechanical stability is typically not an issue. The physical characteristic of the particles can change over time, with the granules becoming brittle and more susceptible to mechanical sheer. Thus if the materials ore part of an additive formulation, product rotation and shelf life can be key issues to ensure adequate mechanical stability during processing.

It is also contemplated that a portion of the visually differentiable granule material can be composes of a mineral such as mica. It is contemplated that polymeric articles formulated into veneer materials made according to the process and disclosure contained herein utilizing minerals would contain mica. Mica is a naturally occurring mineral found in a variety of colors and purities. Mica can be easily colored by binding a pigment-containing layer to its surface, thereby effectively encapsulating it in a color. This is especially useful when the pigment binder contains a silane ingredient.

In view of the foregoing, it has been found, quite unexpectedly, that the use of visually differentiable granules as defined herein, within the aforementioned size distribution parameters, in the presence of a background pigment or opacifier, can create a predictable, repeatable, and measurable means of color pigmentation and aesthetic decoration. Without being bound to any theory, it is believed that granules having sizes in the ranges defined are capable of bending and distortion to take on more natural, variegated shapes during the manufacturing process Additionally, the visually differentiable granules defined herein constitute relatively small weight percentages in a given formulation thereby permitting higher filler loadings relative to other formulations It is contemplated that the loading of visually differentiable granules will be less than 30 percent by weight with amounts less than 15 percent being preferred. Product formulations of the present invention achieve a robust stone-like appearance with as little as 1 percent, and generally no more than 7 percent weight loading of visually differentiable granules.

In a further embodiment of this invention is that some of the suspended granules may themselves be of a substantially water-clear variety. Materials such as glass, polycarbonate, various acrylics, PVC, ABS, and such substantially water-clear three-dimensional granule may be used. By mixing clear granules into the polymeric base resin, voids of an irregular nature are created. This imparts a natural appearance of variegated stone and gives a depth and interest to the overall product.

It is contemplated that the visually differentiable granules will be incorporated into a suitable polymer base resin. Typically, when the resin is employed as a article such as a decorative utility panel, it is contemplated that the utility panel will be composed of at least 70 percent of a suitable polymeric base resin. As indicated previously, the polymeric base resin can be either thermoplastic or thermoset in nature. The thermoplastics contemplated include, but are not limited to, ABS (polymers produced by polymerizing acrylonitrile, butadiene, and styrene), ACS (polymers of polymerized acrylonitrile, chlorinated polyethylene, and styrene), olefin-modified styrene-acrylonitrile, acetyl homopolymer, acetyl copolymer, ionomers, nitrile resins, phenylene-based resins, polyamineimide, modified polyphenylene ether, polybutylene, polycarbonate, aromatic polyester, thermoplastic polyester (polybutylene terephthalate, polytetramethylene terephthalate or polyethylene terephthalate), polypropylene, polyethers ether ketone, polyethers imide, polyethylene acid copolymer, ethylene ethylacrylate, ethylene-methylacrylate, ethylene-vinyl acetate, polyimide, polymethylene pentene, polyphenylene sulfide, nylon, acrylic polymers, polyethylene, etc., as well as combinations thereof. Thermoset plastic are further defined as plastics requiring a chemical additive or external activity to cause a state conversion of the plastic from liquid to solid. Such thermoset plastics include, but are not limited to, allyl esters, amino resins, phenolic resins, unsaturated alkyd polyester, unsaturated polyester, epoxies and melamine.

Preferably, the polymeric resin employed is composed of a translucent material that can receive a suitable amount of the visually differentiable granules. Typically, the polymeric resin will be one that can receive amounts of visually differentiable discrete granules at the desired loading quantities.

The polymeric base resin employed will typically have a melting point below that of the polymer or polymers employed in visually differentiable granules. It is contemplated that the melting point differential between the base polymeric resin and the visually differentiable particles can be one that maintains integrity of the incorporated granules.

In producing objects such as decorative utility panels, it is contemplated that the polymeric base resin containing visually differentiable granules therein will be prepared as a planer material which can then be substantially rigidly bonded to a second material or zone to create a good one-sided semi-structural panel. In the various embodiments as disclosed herein, it is contemplated that the first zone or material will have a thickness between about 0.005″ and 0.5″ with a thickness between 0.01″ and 0.3″ being preferred. The second zone or layer may be composed of a suitable material or materials that will provide the appropriate rigidity and strength to the finished utility panel. It is contemplated that the second zone may be a thermoplastic of lower specification and may be foamed, corrugated, or fluted as desired or required.

It is contemplated that the first and second zones can be affixed to one another in any suitable manner. Thus, the two materials can be coextruded, injection molded, cast molded, or separately processed and bonded, depending upon the needs and requirements of the finished product and the manufacturing processes utilized.

The decorative utility panel can also include an optional third layer that is usually similar in characteristic and material to the first layer. The third layer may be applied to the opposite side of the second zone to create a good two-sided semi-structural panel.

Where desired or required, an optional fourth zone of clear plastic resin can be bonded to the surface of the first zone material to create a wear-resistant surface. The plastic resin of choice may be any suitable material that is resistant to scratching, etc., and capable of bonding to the associated materials.

It is contemplated that the multi-layer material will possess physical properties allowing for very high production and shipping yields. Physical properties such as enhanced impact resistance will permit the object such as a utility panel to tolerate rough handling without shattering or other damage. Without being bound to any theory, it is believed that the material employed in the second zone or layer can greatly contribute to the impact resistance, etc., of the material. It is also contemplated that the material thus produced can be easily cut and rendered waterproof and highly weather resistant. The first layer and/or two-layer material is one which can be bonded to a variety of substrates using a suitable nonspecialized adhesive. Thus, the material can be further attached to suitable pieces of lumber, or construction substrate as desired or required.

The semistructural panel includes at least a first zone or a first and second zone constructed by suitable co-lamination or coextrusion processes as desired or required. It is contemplated that lamination can be performed during the hot extrusion process of the sheet components or, in the alternative, can be performed immediately following an equivalent injection molding process after the different zones have begun to cool. Where desired or required, an appropriate intermediate layer or adhesive material can be interposed between the two zones to provide appropriate laminar adhesion.

It is contemplated that a two-layer or multilayer panel will ideally be made with base materials in each layer having physical characteristics that approximately match one another. Specifically, it is contemplated that the various materials will have respective coefficients of thermal expansion and contraction that differ from one another within tolerable limits. Preferably, it is contemplated that the respective coefficients of thermal expansion and contraction will have a differential less than 40 percent. It has been found, quite unexpectedly, that this is particularly important in two-layer panels, and as it may relate to the granulate material itself. In situations where three-layer panels are constructed in which the first and third layers are composed of the same material, the differential in the coefficients of thermal expansion and contraction can be less tightly controlled. In such situations, it is contemplated that the differential may be at a value approaching 55 percent.

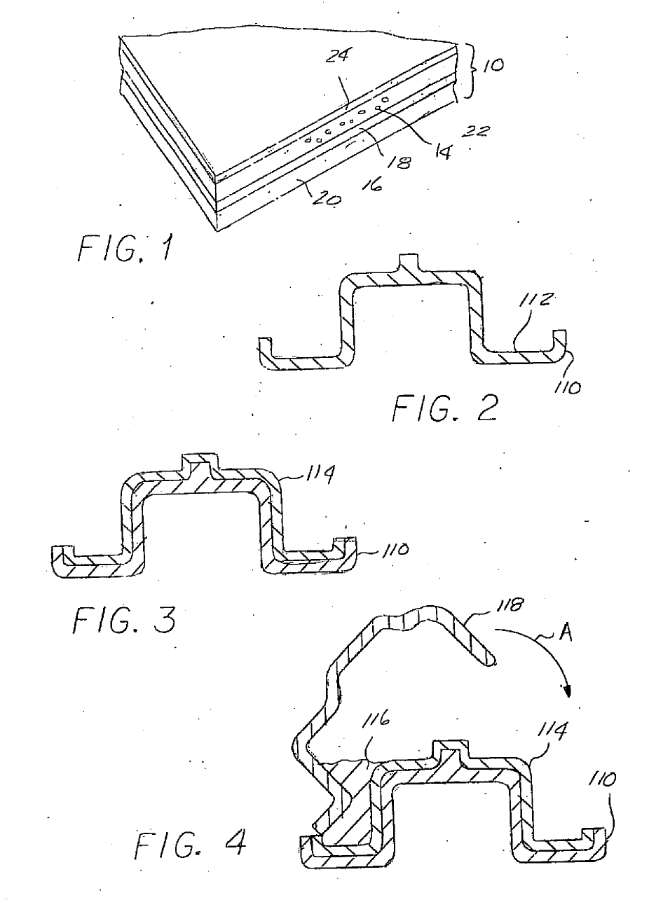

It is also contemplated that the material disclosed herein can be spray applied to a suitable mold surface and molded by various processes. FIG. 2 depicts a mold that may be employed in accord with the present invention for the fabrication of a sink. The mold 110 has a forming surface 112 which corresponds to the exterior surface of the sink. The mold 110 may be fabricated from metal, polymeric material, or composites. One particularly preferred mold structure is comprised of wood which is faced with a relatively smooth polymeric material. FIG. 3 depicts the mold 110 with a layer of solid surface material 114 of the present invention applied thereto. As discussed above, the layer is most preferably applied by a spraying process, although it is also contemplated that the material can be painted on, slurried on, or applied by other techniques such as rotamolding or curtain walling. In those instances where a solid surface article is to be manufactured entirely from the composition of the present invention, the layer 114 is applied to a total thickness corresponding to the thickness of the finished article, allowed to cure in the mold, and then removed. Finishing of the article may require some trimming of flashing and polishing of the article, although use of a polished mold will eliminate or significantly reduce polishing steps. It is to be understood that the layer 114 can be applied in a single step, or a plurality of sublayers can be built up to a final thickness. Curing times and temperature will depend upon the specific solid surface composition being employed.

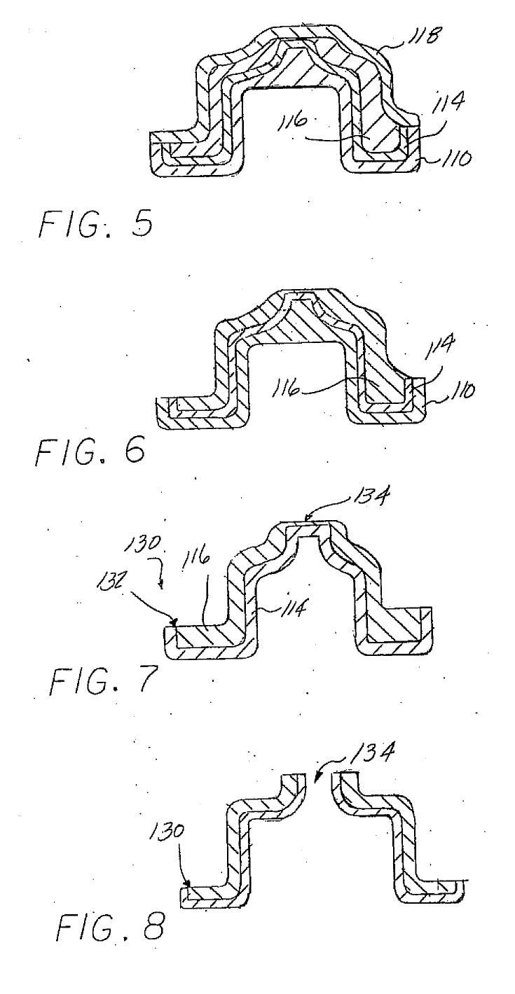

In many instances, it is desirable to incorporate a backing material onto a veneer of solid surface material. The remaining figures depict further steps in the previously discussed process wherein a backing layer is applied to a solid surface veneer layer by a compression molding process, it being understood that other processes may be similarly employed in the practice of the present invention. Referring now to FIG. 4, there is shown the mold 110 and solid surface layer 114 as previously discussed. FIG. 4 also depicts a body of backer material 116 disposed on the back (i.e., unfinished) side of the solid surface veneer layer 114. The backer material 116 is most preferably comprised of a relatively low cost thermosetting resin filled with relatively large amounts of calcium carbonate or similar mineral fillers. This backing material has a fairly stiff, putty-like consistency. As further depicted in FIG. 4, a compression member 118 is hingedly attached to the mold unit 10, and it will be apparent from the figure that by closing the compression member 118 against the remainder of the mold 110, as indicated by a row A, the backing material 116 will be compressed into contact with the layer 114 of solid surface material, and FIG. 5 depicts the mold assembly in such a closed configuration. Though not illustrated, it is to be understood that the compression member 18 may include vents or outlets for allowing trapped air and/or excess backing material to pass therethrough.

As depicted in FIG. 6, the compression member 118 is removed from the assembly, and this may be done either before the backing material 116 is fully cured, or thereafter. In a subsequent step, the article is removed from the mold 110. In an additional, optional step, a layer of solid surface material may be spray coated onto the rear surface of the backing material 116 so as to give a finished article which gives the appearance of being fabricated entirely from solid surface material. This step can be implemented either before or after the article is demolded.

As shown in FIG. 7, the result of the compression molding process is a finished article 130 configured as a sink, and comprising a front veneer layer 114 of solid surface material and a backing body 116 (and optionally a backside veneer). It will be noted that by appropriately configuring the molds, grinding, drilling, and finishing steps can be minimized. For example, the mold can be configured so as to provide a clean edge, for example edge 132 having a wrap-around portion of solid surface material 114 covering the edge of the backing material 116. In such instances, finishing steps will merely involve removal of flashing from the edge. As noted, the article 130 is configured as a sink, and as such includes a drain connection molded therein 134. As shown in FIG. 7, this connection 134 is not yet opened. Final finishing of the article 30 may comprise grinding down the back surface of the drain portion 34 to form a drain opening therethrough. Clearly, by appropriately configuring the molds, this step could be eliminated. FIG. 7 depicts a finished article 130 comprising a sink unit as described hereinabove.

It is to be understood that yet other molding processes may be implemented in accord with the present invention. For example, compression molding processes may be carried out utilizing differently configured molds. Likewise, the materials of the present invention may be used in a non-compression molding process. Also, while application of the material by a spray process has been discussed, it is to be understood that material may be simply cast or painted onto a mold surface. It is an important feature of the present invention that the composition thereof can be utilized in a molding process, and that the surface of the finished article faithfully replicates the surface of the mold thereby minimizing finishing steps. It is also significant that the material of the present invention, when cured, is highly resistant to moisture, thermocycling and ambient atmospheric conditions. Therefore the materials of the present invention can be advantageously employed to fabricate articles such as sinks, washbowls, bathtubs, shower stalls, slap materials, and the like which are exposed to adverse environmental conditions.

To further illustrate the invention disclosed herein, the following examples are given. It is to be understood that these examples are provided for illustrative purposes and are not to be construed as limiting the scope of the present invention.

### EXAMPLE 1

A sheet die of 0.04″ was run with grade A, high translucent polypropylene material filled 7% by weight with shredded thermoplastic granules commercially available from the All Plastics, Inc. under the trade name Deco-Spex. The shredded granules are according to the size distribution outlined in Table I and vary in color. Cured sheets of 0.040″ material in 12″ in width are produced, cut and embossed with a gentle undulation so as to represent a semigloss or matte finish and corona treated to 50 dyne. The sheet was cut 4′×8′ size.

A second extrusion die was set in the extruder. Pigmented, recycled, polyethylene was run in a 0.420″ thick fluted panel. The two panels were laminated in a standard laminating operation using Reactite #R2032 glue commercially available from the Franklin Adhesives Company.

The two materials were adhered to one another and the finished panel assembly was inspected. The finished assembly had the variegated appearance of a natural material such as stone, and a non-reflective matte finish as per DuPont Corian materials. The fluted core panel exhibits incredibly high void development (typically be over 85 percent void). This is in contrast to 20 to 50 percent void development of extruded and injection molded conventional utility panels. A comparison with conventionally produced panels demonstrates that the panel produced according to the present process was lighter and significantly lower in material cost. The panel produced was aesthetically pleasing and provides opportunities for it to be used in applications unfamiliar to “marine panels” of the relevant art such newer applications, requiring a pleasing appearance as building facades, toilet partitions, shower walls, instrument panels, and architectural trim and accessories (e.g. waste containers or park bench stanchion).

To achieve a finished appearance to the edges of a panel, a unique edgebanding system was incorporated utilizing a c-channel extruded from thermoplastic. A unique design interlocking and adhesively. bondable to the panel creates a substantively seamless appearance and structurally sound, self-aligning field-installable joint. A matching router bit was designed to allow for an easy field fabricatable edge finishing.

### EXAMPLE 2

High water clarity polyethylene resin is mixed 20 percent by volume with glass frit having a size from US 149 mesh to US 40 mesh commercially available from Strategic Minerals Company of Pennsylvania and 12 percent by volume with colored mica flakes commercially available from All Plastics of Waterford Mich. The resultant mixture is then injection molded to a 0.25″ thickness. The finished sheet greatly resembles the natural voids, color variation, and inclusions of natural stone. This sheet is fabricated in the field as desired into instrument panels, boat and RV turn and the like.

### EXAMPLE 3

An A grade thermoplastic polyethylene that is translucent and substantially water clear is mixed with 8 percent by weight with granular material formed from shredded bio-polymer film commercially available from All Plastics under the trade name Deco-Spex in the ranges defmed in the specification at Table I. This material is run through a 0.040 sheet extrusion dye. Panels are cut to nominal useful sizes, crated, and can be distributed.

### EXAMPLE 4

A multi-layer panel is produced to evaluate characteristics such as enhanced toughness for exterior architectural applications and other high abuse applications is assessed. A first outer decorative layer of a resin formula of substantially water clear polyethylene is mixed 20 percent by weight with calcinated alumina varying from 2 to 30 microns, 7% colored Mica and 2% Deco-Spex, all sized according to Table I. The first zone is 0.02″ thick. The second zone containing recycled HDPE is coextruded, thereto as a backer to a thickness of 0.04″ and the resultant panel is light, rigid, and modest in cost to produce, distribute, and fabricate into place. This panel is also highly abrasion resistant.

### EXAMPLE 5

A Grade “A”, substantially water clear polypropylene is mixed with 7 percent shredded cellophane plastic film by weight available from U.C.B Film of Georgia, and 20% CaCO₃. The film is selected in three colors, shredded at room temperature, and all resultant granules are within the size distributions outlined in Table II. The resulting formulation is extruded to 0.060″ sheet. A clear protective layer of vinyl polymer is co-extruded at the same time, yielding a 2-layer panel with a protective clear cap, bearing remarkable scratch resistance.

### EXAMPLE 6

A formula of 6 percent colored mica granules available from All Plastics under the trade name “Ultra Gran”, and 20 percent CaCO3, and the balance of a translucent grade of HDPE resin and a background pigment is compounded in standard fashion. The material co-extruded with a layer of 0.015″ clear ABS over the top surface allowed to cool sufficiently and cut to 4′ by 8′ sheets. By the mica granules following the outlined size distribution herein, the sheet bears a striking resemblance to trade materials such as CORIAN® and to natural stone, upon durability testing, the panel, with its clear protective layer, has an almost scratch-proof quality.

The produced panels are further bonded to a sheet of ordinary particle board or MDF board, respectively. The board may be fully fabricated into a countertop as with Formica®-type laminates, or it may be v-grooved. Either way, the resultant countertop reveals incredible beauty, durability, and at a price no different from ordinary laminates on the market today.

### EXAMPLE 7

A mixture of HDPP, 20% CaCO3, and 8% Deco-Spex is blended by weight and compounded. The material is then run through a twin-screw extruder through and into a 0.025″ sheet dye. The material is then co-laminated to a sheet of gypsum “drywall” paneling, creating a pre-finished stone-like panel that is water-proof. The resulting panel material has a striking resemblance to solid surface trade materials and to natural stone. Upon durability testing, the panel is not as tough and abrasion resistant as some of the other examples, but is much tougher than most commercially available paints or wallpaper materials.

### EXAMPLE 8

A formula of 8 percent granule flake material as outlined in Example 7 is incorporated into a thermoplastic acrylic based resin. The material is extruded into a 0.40″ sheet and is capped with a clear acrylic film having a thickness of 0.0003″. The material demonstrates durability upon testing and has an almost scratchproof quality.

### EXAMPLE 9

Material produced according to the process outlined in example 8, above is thermoformed into the shape of a vanity sink, including an outer rim. The resultant article is backed with injection-molded foam to provide appropriate thickness and rigidity to the article. The resultant article greatly resembles injection-molded Solid Surface sinks weighing three times as much. Injection molded sinks typically cost more than 4 times more than articles produced according to the process outlined. The resulting formed sink is exposed to thermal stress by repeated exposure to cold and hot water. This process mimics the conditions which occur in a sink when a person washed his hands with water that is at first cool and warns as hot water becomes available to the faucet. This sink is impervious to “blushing”, whitening of the polymer material under thermal stress of repeated exposure to cool and hot water. The sink is also greatly resistant to thermal shock due to the same thermal forces described for blushing.

The sink is compared to three sinks: each sink is prepared by one of the traditional solid surface materials methods. In the first method the sink is formed by injection molding. Observation of the sink made by this method indicates that the roundish prior art granules do not expose themselves well to the viewing surface of the injection-molded part. Therefore the shaped part's viewing surface must be abrasively planed to expose the granules. This is a difficult task and is much more complex than as done to flat sheets due to the contours of the part. The second sink is formed by a method of careful thermoforming practiced by a small number of companies around the world. One disadvantage is that there are significant limitations on shape produced. Thus only articles with gradual, sloping shapes can be formed. This second method fails to produce a steep-sided kitchen sink shape as can be produced by the method outlined herein. can be made. A key reason for this is the well-documented problem of particle migration wherein the particles “stretch out” along deep draft areas of the part and create a “smeared” visual appearance. The third sink is one produced by a process of spray process and casting in gas outlined in Bordener U.S. Pat. No. 5,885,503, the specification of which is incorporated by reference herein. The sink produced by this process has some shape limitations as to what can be sprayed. If the shape contains any narrow areas, for example a spray head simply cannot hit this area. Another disadvantage is sinks made though this method have, thus far been heavy, and more difficult to ship.

Sinks produces according to the method outlined in this example do not exhibit the shortcomings of the three methods of the relevant art. The sinks produced by the method outlined herein are light, with an even color pattern due to the fact that the granule density of the mix can be increased prior to extruding the base sheet to thermoform. This creates a granule blend with a high degree of “overlap” in the interstitial areas between the various discrete granules. Without being bound to any theory, it is believed that this phenomenon eliminates the “smearing” effect, referred to as [visible] particle migration in thermoforming traditional solid surface materials. Further, the relatively thin thermoplastic sheet is made from materials inherently compatible with thermoforming operations. Sinks made by the present example of this invention are superior in physical performance, appearance, uniformity of color, weight and cost reduction, and robustness in handling for shipping, even to the point of being able to ship the resulting sinks individually in a simple box that can be literally dropped off a truck.

### EXAMPLE 10

Material prepared according to the process outlined in Example 7 is extruded into thermoplastic siding for home construction. The material demonstrates appropriate characteristics for use as thermoplastic siding, with an appearance of stone. The “siding” can be shaped as shiplap as is common practice or an interlocking planar shape as done in faux cedar shake-type siding. The interlocking pattern is modified to resemble stone joinery of fieldstone and the like.

### EXAMPLE 11

Material prepared according to the process outlined in Example 7 is injection-molded for use in complex geometry articles such as automotive interiors, coffee mugs, and the like. Suitable injection molding characteristics and articles are produced.

### EXAMPLE 12

Compression molded stone-effect thermoset-based plastic is prepared according to the process outlined in U.S. Pat. No. 6,517,897 utilizing the material as disclosed herein. The material can be used for items such as countertops and sinks and the like. An extremely thin veneer stratum is employed over an appropriate substrate that produces a convincing stone visual effect. A veneer of typical unsaturated polyester resin gel coat is sprayed into a mold. The gel coat contains 8% Deco-Spex from All Plastics of Waterford, Mich., 12% spray grade ATH from the RJ Marshall Company, of Southfield Mich. and less than 1% pigment form Bro-com Corporation. The material is allowed to set up appropriately and then, a pre-measured amount of compounding material is placed into the mold and the mold closed. The material is visually investigated. The material is visually indistinguishable in appearance to solid surface materials as distributed under the trade name Corian, or manufactured according to the processes outlined in U.S. Pat. No. 4,544,584 to Ross, or U.S. Pat. No. 6,517,897 to Bordener without modification.

### EXAMPLE 13

A typical bulk molding compound is prepared from thermoset resin and ATH mineral filler, the mixture also includes 13% high aspect ratio granules made from bio-polymer sold under the trade name Deco-Spex. The material is de-gassed and molded without gel coat as is typical bulk molding practice. The material is a true Solid Surface but is made with the elusive process of bulk molding, which has never before been done successfully with Solid Surface materials. The difference here is where the prior art-granule-based attempts failed because the extreme opaque nature of bulk-molding materials block the granules from being visible. In the process employed herein the high aspect ratio of the granules [exceeding 20] provides the granules with sufficient visibility to provide a good representation of Solid Surface. The bio-polymer construction also helps as the granules tend to fold and yield rather that be ground to a fine powder under the high pressures and temperatures of bulk molding.

### EXAMPLE 14

Standard cast polymer industrial gel coat, made from unsaturated polyester resin is filled 20% with ATH from Huber Minerals, approximately 2% pigment from Bro-Com and 4% with fine granules under the trade name Deco-Spex from All Plastics. The granules are all the same color and are the same color as the pigment so as to create a solid color, but one with natural shading and slight variation of a more natural material such as a glass and less of a “plastic” appearance as can occur when a formulation of ATH mineral, pigment and gel coat alone is produced. If some or all of the ATH is substituted with glass frit or silica an even more varied appearance results, resembling glass with natural inclusions

### EXAMPLE 15

In a process similar to example 14, above, a blend of 5% Deco-Spex, composed of all one color and all granules smaller than 0.008″, approximately ½% dispersion dye in the same color as the granules, and 20% CaCO₃ is compounded with HDPE and extruded into a film of 0.010″ thick. This film is then laminated to a sheet of medium density fiberboard (MDF), making the sheet waterproof, scratch resistant, and giving it the appearance of a glass-like material, all at a minimal cost and with environmental impact.

### EXAMPLE 16

A standard sheet of prior art material is prepared for casting into a typical ½″ sheet. 1.5% of Deco-Spex from All Plastics is added to the mix prior to pour and homogenously mixed in. The new granules are all white in color and larger than 0.1″ and smaller that 0.2″ in size, the remaining prior art granules are all according to size distribution in Table I. The resultant mixture is planed to expose the granules.

A comparison sheet using prior art granules is also prepared with the prior art granules having an aspect ratio of 1 and a size between 0.004″ and 0.1″. The sheet using prior art granules for the larger white size the sheet would required planning of 3/16″ to expose the granules. This is expensive and environmentally wasteful. With the larger granules of the new invention used, the sheet need only be planed 3/32″ as it would have anyways, saving approximately 0.25 cubic feet of Solid Surface material. This equals roughly 6 square feet of material at standard ½″ thickness and weighs approximately 28 lbs; a significant savings and gain in efficiency. Visual observation indicates that the sheeting produced by the method outlined herein is indistinguishable from typical materials that cost more to produce and wasting more in production.

### EXAMPLE 17

A coffee mugs are prepared by from recycled HDPP resin using standard injection molding techniques. The recycled HDPP material is whitish and highly opaque. Recycled HDPP is blended with 2% of Deco-Spex granules in a single color. The material is injection molded and yields a cup having a lightly softened and variegated appearance. The mug produced containing 2% Deco-Spex bore some resemblance to stoneware at a low cost.

### EXAMPLE 18

Wide spec HDPE resin is blended with granules formed from colored mica from All Plastics, and 20% CaCO₃. The granules are upsized by trial and error thru the process to yield granules with a final size in the sheet according to Table II. The resultant sheet has a remarkable appearance to natural stone. Comparison with other product in the industry indicates that the resulting sheet resembles none of the mica-based plastic sheets anywhere in industry. The resulting sheet is the laminated with a clear plastic cap layer of vinyl to impart scratch resistance. The sheet is then D-Corona —treated to 55 dyne on the backside. The treated sheet is laminated to a sheet of common particle board (Industrial board). This panel assembly is then run face up over a v-grooving machine as is common practice in the Solid Surface Industry to prepare the sheet for built-up face edging and backsplash. The grooved sheet is then glued with standard aliphatic wood glue and allowed to cure. The resulting countertop assembly has an attractive 45 edge and 45 degree “coved” attached backsplash. It should be noted that this counter surface, edge and backsplash feature an unbroken surface over the entire face, rendering the article that is waterproof and free of visible seam lines.

### EXAMPLE 19

A unsaturated polyester resin with thixotropic and wetting agent additives commonly referred to as gel coat is prepared for use in spray process solid surface manufacturing similar according to the process and field as described in U.S. Pat. No. 5,476,895 to Ghahary, and U.S. Pat. No. 5,885,503 to Bordener. The gel coat is filled with 10% ATH commercially available from RJ Marshall Co, 8% Deco-Spex from All Plastics. The granules are made from a biopolymeric material, in this case a water soluble regenerated cellulose (e.g. bio-polymer). The granules are sized according to the distribution outlined in Table II of the specification. This creates a solid surface veneer spray processable mixture. The resulting mixture is sprayed into a vanity top and sink (ITB) mold obtained from Gruber Systems of Valencia Calif. Upon gelling of the spray applied solid surface veneer material in the mold, the balance of the mold is then filled with standard industrial casting material as described in Bordener '503. This is a mixture of unsaturated polyester casting resin blended with approximately 75% CaCO₃, as typically used in the cast polymer industry. The resulting article is visually inspected and is determined to be indistinguishable from materials produced by processes such as those outlined in Bordener, Ghahary and Ross, as well as products commercially available under the trade name “Corian”. The product is made from a thinner outer veneer than possible with both the aforementioned Ghahary and Bordener prior processes and materials, resulting in a 30% emissions reduction in spray process, further still that the granules themselves are made from an emissions-free process.

The products are produced in the manner outlined herein with reduced materials cost both as pertains to the granules themselves and also pertaining to the complexity and cost of the resin. Observation of the resulting gel coat materials indicates that the inventive granules are mostly self-suspending in the gel coat permitting less costly suspension technologies can be employed. Additionally visual observation of the resulting, the solid surface veneer coating indicates that the high aspect ratio particles employed exhibit more dense particle packing. Given the density of the particle packing, thinner sheets can be utilized in achieving similar effect. It should also be noted that resulting material has lower environmental impact because the granules are produced in an emissions-free process, contrary to prior-art granule where styrene emissions are generated in great quantity.

### EXAMPLE 20

A standard water-clear gel coat (commercially available from H.K. Research of Hickory, N.C. as resin #G1175) is sprayed into a mold. Prior to fully curing, a second spray coating is applied over the gel coat such that the two applications of gel coat will cross link together. The formula for the second application is composed of a gel coat with 8% opaque pigmented mica, 12% ATH, and 0.5% pigment-yielding an excellent resemblance of traditionally accepted solid surface materials. Upon gellation of the two veneer coatings in the mold, the mold is subsequently filled with standard casting resin (unsaturated orpthothallic polyester resin) mixed 78% with CaCO₃ and color-coordinating pigment. The fixture is at least partially cured and removed from the mold, deflashed and buffed to yield an engineered stone part at low cost and with extremely high water-proof characteristics.

### EXAMPLE 21

A gel coat resin is mixed with granules as disclosed herein made from plastic materials having an aspect ratio of at least 5, the granules having a thermal coefficient no more and no less than 30 higher or lower than the media resin they are immersed in. This ensures that the total article resulting will perform well with respects to thermal stresses such as with water exposure in a sink.

### EXAMPLE 22

A mixture such as in Example 20 (?) is prepared except that the granules of the second gel coat formulation are made from PVA (polyvinyl acetate flake) as available from EpoxyTech Company of Troy Michigan. The resulting article is an engineered part having pleasing aesthetic characteristics.

### EXAMPLE 23

A thermoplastic sheet is colored with plastic granules. The granules have an aspect ratio of at least 5 and a coefficient of thermal expansion and contraction as in Example 21 The resulting extruded sheet possesses superior thermal resistance to damage from temperature extremes of water, and thermal shock as in a sink or from weather exposure.

### EXAMPLE 24

A sheet of ½″ standard solid surface materials is to be prepared. The mixture contains densified resin suitable for solid surface manufacture, and ingot-type granules. A small percentage of granules with an aspect ratio of at least 5, and least dimension (thickness) less than 0.020″ is added to the mixture. The inventive polymeric granules disclosed herein are used in large sizing to create a “large granule” look without the added process of additional abrasive planing to expose the hemispheres of these granules.

### EXAMPLE 25

A sheet of ½″ standard solid surface materials is to be prepared. The mixture contains densified resin suitable for solid surface manufacture, ingot-type granules. A small percentage of biopolymeric granules with an aspect ratio of at least 5, and a least dimension (thickness) less than 0.020″ is added to the mixture. The inventive granules disclosed herein are used in large sizing to create a “large granule” look without the added process of additional abrasive planning to expose the hemispheres of these granules.

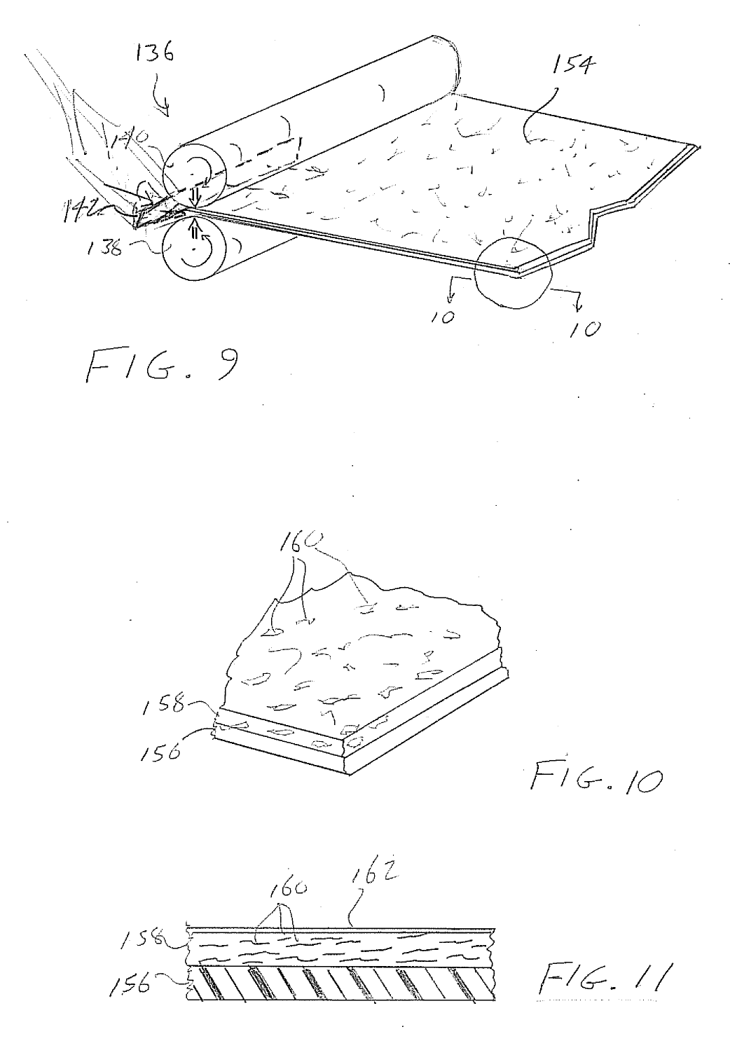

Referring now to FIG. 9, an environmental view is shown generally at 136 of a combined resin flowable and pressure application process for creating an article exhibiting substantially parallel oriented granules according to a further preferred embodiment of the present invention. As will be further described in detail, the successive illustrations of FIGS. 9-12 describe the manner in which hydraulic (or other suitable applied pressures/forces) may be utilized in the formation of a thin resin based decorative article, and in such a fashion as to encourage the formation of high aspect granules in a substantially parallel aligning and equally dispersed fashion in order to create an article exhibiting desired aesthetic characteristics.

The present invention in particular discloses a method for preparing a polymeric article such as, but not limited to, any constitution of polymeric utility panel, such as described above, and having any form of three-dimensional aesthetic color characteristics. The preparation method includes the steps of mixing the granule-based coloring system described herein into a suitable polymeric base material.

The polymeric base material with the admixed visually differentiable granule material contained therein is formed into the desired structure, such as by coextruding, co-laminating, injection molding, bulk molding, rolling and curtain walling processes, castable processes, thermoforming or the like, a thin planar sheet structure. In the illustration of FIG. 9, a pair of rollers 138 and 140 representing an associated process for forming a fluid based resin material (with suitably entrained granules), as further shown at 142, into a thin, flat sheet of a resultant resin based product.

A feature employed in the parallel alignment of the high aspect entrained granules is the application of a first force (e.g. hydraulic) as represented schematically at 144 in FIG. 12, and as opposed to a second such force, at 146, the forces acting in both substantially parallel and perpendicular directed fashion, respectively, relative to the viewable surface of the article to be created. FIG. 12 further illustrates, generally at 150, the formed article with a plurality of entrained granules 152, the article further being represented as a single sheet, with the understanding that two, three or more layer constructions are possible within the scope of the invention and depending upon the type of formation process employed.

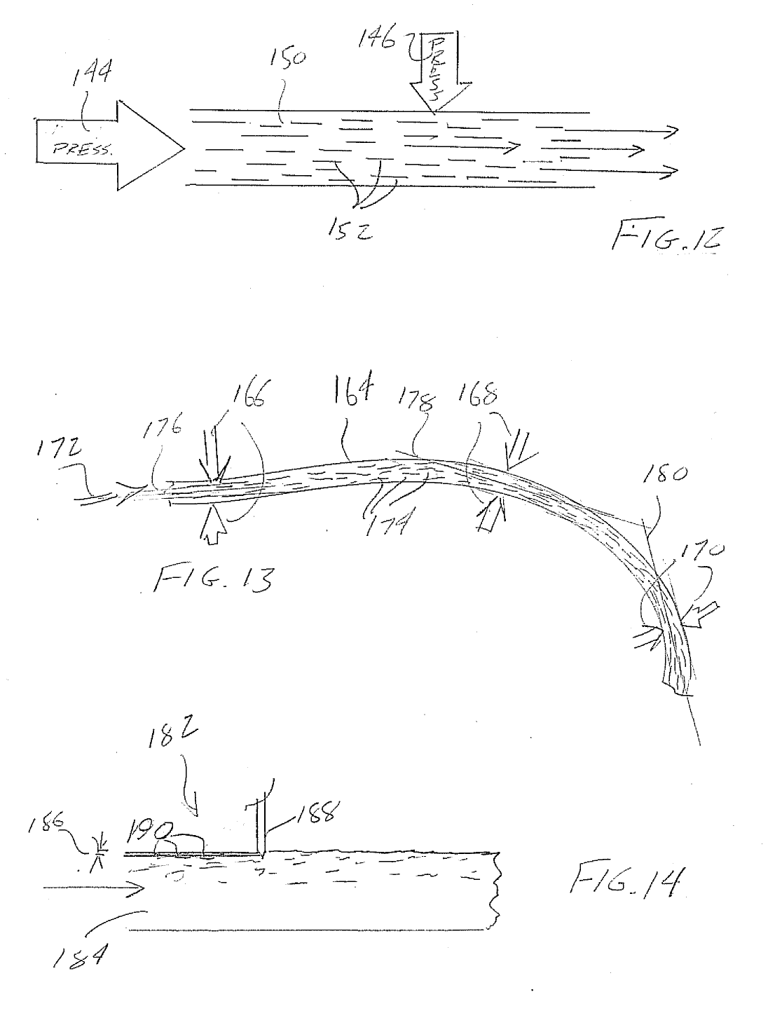

Referring again to FIG. 9, the resulting polymeric article (e.g. at 154), such as a polymeric utility panel, possesses aesthetic characteristics such as the appearance of natural stone or glass. The polymeric article may also exhibit aesthetic characteristic which mimic attributes metal effects including, but not limited to, copper, brass, cast iron and the like. Reference is made to FIG. 10 and which illustrates an enlarged partial view of a two layer article (see layers 156 and 158, and by which the plurality of granules 160 are substantially aligned in parallel fashion. Referencing further FIG. 11, a similar side plan arrangement is shown of an article such as that according to FIG. 10, with the further understanding that a clear top coat or other top protective layer, at 162, can be applied over a single or uppermost co-extruded/co-laminated layer, e.g. again at 158, within which is substantially contained the dispersed and aligned granules 160.

In a preferred application, applied hydraulic force or pressure, such as which may be applied along a planar direction and in cooperation with a separate linear directed hydraulic force associated with a sheet article formation step (similar to that representatively shown in FIG. 12), will cause the associated granules 152, these typically comprising high aspect granules and which are defined as including both organic and/or inorganic entrained particles exhibiting an average maximum length or width at least twice that of a respective thickness (aspect ratio of two) or greater. In further preferred applications, the average aspect ratio of the granules can be much greater, such as by a factor of six or more.

Again among the unique features of the hydraulic applied pressure gradient across the fluidic resin medium is the ability to align the high aspect ratio granules in a substantially parallel and evenly dispersed fashion. It has been found that the application of the hydraulic pressure, from regardless the direction, will further cause the granules to flow in a substantially laminar direction during the formation of the sheet (by whichever preferred process is selected). The granules may further exhibit a density either equal to that of the resin medium within which it is dispersed/entrained (thereby rendering them isopycnic) or, alternatively, may exhibit a greater density than that of the associated medium without any significant degradation of their realignment protocol.

In preferred applications, it has been found useful if the associated orifice (see again as generally representatively shown at 142) itself exhibit an aspect ratio (e.g. be defined in a substantially rectangular configuration as is generally represented), this ranging upwards of a ratio of 3-5 times of width versus its thickness or height. Desired orientation of the granules further result from the flow dynamics introduced into the resin matrix and by which a quasi-laminar flow is created within the stratum via the widened opening of the orifice through which passes the combined resin granule syrup.

Superior orientation has also been noticed in situations where the granule containing stratum has been reduced to a range of 23-30 mils. Additionally, a more opaque resin matrix can be employed with a thinner system, this providing an opportunity to further reinforce and/or cheapen the cost of the material. In one further desired application, a material dispersion orifice can range between 150-300, the granule content itself exhibiting a range of about 0.2″ to 0.15″ in planar size with a thickness of approximately 3-4 mils and a maximum aspect ratio of 35-50.

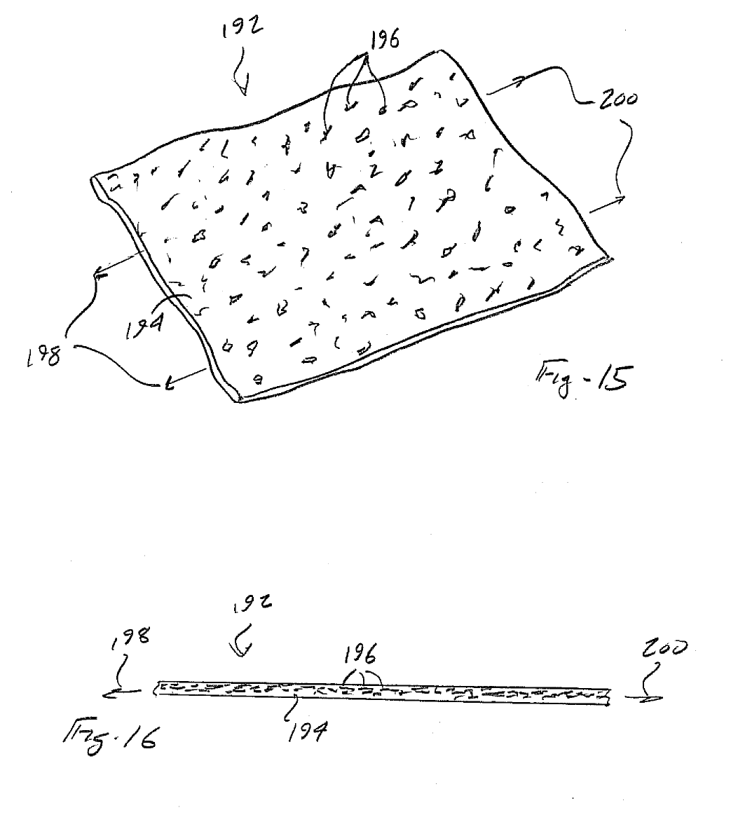

According to a further application, and as is shown with reference to FIG. 13, a substantially non-parallel article, see at 164, can be created by locally applying desired forces, e.g. at 166, 168, 170, et. seq., such as in opposing and combining fashion with a linear directed force 172. Alignment forces acting on granules 174, again occur in a combined parallel and/or tangential fashion, see lines 176, 178 and 180, respectively and which represent different locations alignment locations about the non-continuous (arcuate) profile of the three dimensional article exhibiting the curved (substantially non-planar) form, such as a sink bowl or the like.

A desired feature in aligning granules parallel in a non-continuous article is to cause the granules to flow, within the matrix, in a substantially lamninar direction at certain points, either parallel or tangentially depending upon the degree of curvature of the article created (such as within an injection molding cavity). A key aspect in encouraging parallel alignment of the granules is to maintain a desired balance between the linear and viewable surface applied forces.

The granules themselves may include thin flakes or dry powder. They may be made from one of two basic materials; the first is cleaved minerals such as mica, which is opaquely coated to create a color, the second is shredded (or die cut) plastic film. The film may be coated on its surfaces (esp. when using clear film), only on one surface, or homogenously. Both materials are typically less than 0.010″ thick and are substantially indistinguishable from another when cast in into plastic resin.

Referring to FIG. 14, an illustration is shown generally at 182 of a post production scraping/abrading process step intended to highlight the scratch/mar, heat and light resistance of an article 184 created according to the present process, and to provide an improved appearance. The present method contemplates the “roughening” of the surface of the associated article created, this being caused by the removal of a selected thickness of material (see at 186) such as by a sheet width defining blade or abrader (see at 188) and in order to reveal a top layer of entrained granules (e.g. further at 190) (such as to a depth of 0.001″ to 0.01″ or from 1 mil to 10 mils).

The benefit of this post production step is to create a fully exposed stone surface associated with the faux article created, this further resulting in a scratch/mar, heat and light resistant article providing an improved appearance, especially if uncolored raw granules are blended in with a colored granules or an otherwise colorized/veined substratum. Particularly beneficial to this process is the use of stone/mica granules in plate-like form and in order to create a richer granite effect.

Referring to FIG. 15, an illustration is generally shown at 192 of a further variant of the present method, and which employs a tensile force application to a molten state, semi-hardened sheet 194, and in order to properly align entrained and high aspect ratio granules 196. As is contemporaneously shown in the side view illustration of FIG. 16, the substantially aligning nature of the entrained aspect ratio granules resulting from hydraulic influenced forces, applied in a substantially linear direction to the molten sheet 194 (i.e., such that a greatest lineal dimension of each extends substantially parallel to an associated surface of said sheet) and as is referenced by opposing linear generated forces 198 and 200, see as is generally referenced by directional arrows in each of FIGS. 15 and 16.

The descriptions of FIGS. 15 and 16 are intended to represent any manner in which a limited, non-destructive tensile force is applied in a generally linear direction to a semi-molten sheet, causing desired and substantially linear realignment of higher aspect ratio granules, and without any resultant long term effect to the resinous sheet upon hardening/setting. The method of the present invention further contemplates any suitable force hydraulic application of force to granules entrained within a molten state sheet formed material, this desirously causing the granules (by virtue of the hydrodynamic forces transferred from the surrounding viscous state plastic) to realign, to an optimum visually and decorative revealing orientation, the decorative granule. Consistent with the embodiments previously discussed, the ability to maximize the visual and decorative effect of the entrained granules results in the ability to achieve an optimum overall effect with a reduced sheet thickness.

Another related aspect ratio realignment scheme contemplates heating an existing thermoformed sheet of resin material, within which higher aspect ratios are pre-entrained in any oriented fashion, up to its heat deformation temperature but without exceeding its liquification temperature (this further defined as a temperature point at which the thermoformed matrix achieves its lowest degree of hydrodynamic viscosity in a substantially fluidic (non-gaseous) state. At this point, the heated and substantially sheet formed matrix is placed in a likewise tensile stress condition, this preferably exceeding its point of elongation at this elevated temperature/molten state. By elongating the resin (in its substantially linear extending direction) a further 10%, a laminar flow pattern is initiated which greatly resembles that of a “high aspect ratio orifice” process. In this manner, another means is achieved and by which a quasi-laminar flow and substantially parallel particle orientation is achieved, such as again parallel to a viewable surface of an article or sheet. It is further worth noting that such a heated article surface need not be completely or even substantially planar, it being contemplated that curvilinear (three dimensional) surfaces are capable of being heated, tensile formed, and granularly realigned in the manner described herein.

Additional preferred applications include, and are not limited to feeding a thermoplastic based resin into an extruder, co-feeding a volume of a granule material substantially at a downstream location relative to a substantial input point associated with the resin material; and providing the granules with an aspect ratio of at least 4 as defined between its average planar dimension and thickness. The granules may further exhibit up to 0.6″ in planar dimension upon traveling a distance of at least 6″ along a barrel assembly.

Color controlling the granules is also desired to exhibit at least two visually differentiable colors in the resultant article created, and farther by which at least 1/3 of the granules change at least one of a color, hue, shape, or size during processing. The step of extruding the granules entrained thermoplastic compound into a sheet can also be accomplished via removal of substantially all screens and blockages in an associated extrusion process finer than a 50 mesh rating.

As described previously, a preferred application, includes curing a three dimensional and substantially planar sheet article created into at least two layers. A specified one of the layers can define a granule-containing layer and exhibiting a thickness of between 0.006″ to 0.25″.

As previously described in reference to the teachings of FIGS. 9 et seq., the step of creating a laminar-like flow during formation of a three dimensional sheet, can be modulated such that at least 20% of granules above 0.1″ in planar dimension substantially align themselves parallel to one another as well as to a viewable surface of the sheet. As further described previously in FIG. 14, the step of mechanically removing a portion of a topmost layer is accomplished to apply/provide a mechanical-abrasive finish thereto.

Additional features include providing the thermoplastic based resin with at least one of a olefin, acrylic and ABS material, coextruding an opaque backer layer onto a rear associated surface of a primary sheet, and optionally coextruding a clear protective cap onto a top associated surface of the primary sheet. The step of abrasively planning the sheet top surface may also include removing material to a depth of not less than 0.01″ and not more than 0.25″.

Other and additional steps include heating the sheet and drawing it over a wood-based substrate material conforming to at least one of a shelf, countertop, door, molding, or architectural improvement. The extruded/casted/co-laminated sheet may also be created to exhibit a pre-application thickness of in a range of between 0.018″ to 0.120″.

Yet additional related features include providing the granules be less than 40 US mesh, and only clearing obstructions from the system below 70 US mesh, as well as adding an opacifying agent including at least one of a pigment or a comparable dispersion dye to the granule-containing layer to create a stronger background color. In a further application, the resin granule mixture is extruded into a sheet, and then is thermoformed over a wood-based scrim, the sheet exhibiting a thickness of between 0.02″ to 0.1″.

Also disclosed herein is a bulk molding process for producing a high aspect ratio, high compressive strength granule within a bulk molding compound. This typically includes the steps of applying pressure to an admixture of bulk molding and granule in an extrusion process and, prior to final curing of the compound, exposing the compound and granules to a surface of the article to be made including at least one of a slab, sink or wall panel.

Additional features associated with the bulk molding process include substituting the sheet extrusion process with injection of the melt into an article die to create at least one of a ink, shower pan, and vanity top or of substituting in favor of mixing of a thermoseeting gelcoat and spraying into a negative cavity mold. Yet additional steps include applying the compound to a scrim backer of a differently colored material including at least one of wood, foam, and mineral filled plastic, as well as preparing a common formulation of ingot-type granules and adding a percentage of a pigment prior to casting the article.

Having described my invention, other and additional preferred embodiments, forms, and arrangements of parts of the invention will be apparent to those skilled in the art to which it pertains and without deviating from the scope of the appended claims. Therefore, the foregoing description is to be considered exemplary rather than limiting, and the true scope of the invention is that which is defined in the following claims.

1. A method for preparing a polymeric article comprising the steps of:
admixing a visually differentiable granule material, the visually differentiable granule material including a polymeric film having a thickness between 0.0001 inch and 0.0200 inch, the visually differentiable granule material being composed of granules having at least two colors, the granules having an aspect ratio of at least 2;
integrating the admixed visually differentiable granule material into a polymeric base material; and
forming the polymeric base material with the admixed visually differentiable granule material integrated therein into a polymeric article.

2. The method of claim 1 wherein at least 50 percent of the granules have a mean diameter greater than 0.002 inch and smaller than 0.1 inch.

3. The method of claim 1 wherein less than 20 percent of the visually differentiable granules have a mean diameter less than 0.004 inch and at least 50 percent of the visually differentiable granules between about 0.004 inch and 0.090 inch.

4. The method of claim 1 further comprising the step of integrating a pigment or background dye into the polymeric base material in an amount sufficient to provide a homogeneous background color to the resulting polymeric article.

5. The method of claim 1 wherein the base plastic material containing admixed visually differentiable granules is extruded as a melt-processible.

6. The method of claim 5 wherein the base plastic material containing admixed visually differentiable granules is sprayed onto a substrate material.

7. The method of claim 1 wherein the base plastic material containing admixed visually differentiable granules is cast onto a suitable mold.

8. The method of claim 6 wherein the forming step comprises: spraying the polymeric material with the visually differentiable granules contained therein into contact with a substrate surface.

9. The method of claim 5 wherein the substrate surface is at least one of a mold surface, a backing surface, a stone surface, a polymeric surface, and a wooden surface.

10. The method of claim 5 wherein the substrate surface is a releasable mold surface and wherein the method further comprises the step of introducing at least one additional mold processing material into a cavity containing the mold surface and sprayed material.

11. The method of claim 8 further comprising the step of spraying an essentially clear coat polymeric material into contact with the substrate surface prior to spraying the polymeric material with visually differentiable granules.

12. The method of claim 5 wherein the visually differentiable granules have an aspect ratio of at least 5 and are composed of at least one of pigmented mica, biopolymer, and plastic film.

13. The method of claim 9 wherein at least one of the sprayed essentially clear coat polymeric material and the sprayed polymeric material with visually differentiable granules is at least partially thermosetting and wherein the method further compresses including at least partial cross-linking of at least one thermosetting resin.

14. The method of claim 5 wherein the polymeric base material is a gel coat resin and wherein the visually differentiable granules have an aspect ratio of at least 5.

15. The method of claim 5 wherein the visually differentiable granules have a thermal coefficient, the thermal coefficient being within 30 of that exhibited by the polymeric base resin material.

16. The method of claim 5 wherein the visually differentiable granules further include ingot-derived granules having an aspect ratio less than 2 and wherein the ingot-derived granules are at least 25% of total visually differentiable granules, and at least 0.2% of the visually differentiable granules have an aspect ratio of at least 5 and a thickness of no more than 0.010 inches.

17. A method for forming a resin based article within which are entrained a plurality of granules, at least 2% by weight thereof exhibiting an average aspect ratio greater than two, said method comprising the steps of:
causing a flow of a resin-based matrix containing at least a resin material in a substantially laminar direction with the granules entrained therein;
applying a continuous pressure along at least a direction substantially parallel to at least a viewable surface associated with said matrix concurrent with defining a three dimensional article; and
orienting at least 20% of the granules exhibiting a mean planar dimension of at least 0.004″ in at least one of a substantially parallel and evenly dispersed fashion across the viewable surface of the article.

18. The method as described in claim 17, further comprising the step of forming said laminar flowing matrix into a substantially sheet shape with a specified, length, width and thickness, said thickness being limited to no greater than ½ of a width of a plane representing a mold for producing said sheet, said length further comprising a dimension at least four times said thickness.

19. The method as described in claim 18, further comprising the step of varying an applied pressure component to said sheet at specified intervals in an associated extrusion process, and in synchronization with a granular aspect ratio issued at an orifice location of said mold.

20. The method as described in claim 19, further comprising the step of configuring an area of said orifice so that at least 50% of a maximum aspect ratio of an associated tool configuration of said mold is placed following a decreased pressure zone, and further prior to a succeeding zone of increased pressure.

21. The method as described in claim 17, further comprising the step of employing at least one of a co-extrusion, co-lamination, injection molding, co-injection molding and bulk molding processes in the creation of the three dimensional article.

22. The method as described in claim 17, further comprising the step of applying the flowable matrix through an orifice exhibiting a width at least three times that of a corresponding height.

23. The method as described in claim 17, further comprising the step of forming a sheet exhibiting a thickness in a range of 8-135 mils.

24. The method as described in claim 17, further comprising the step of forming a sheet exhibiting at least two strata therein.

25. The method as described in claim 24, further comprising the step of forming the three dimensional article with the granules entrained within an upper most of said plurality of layers.

26. The method as described in claim 17, further comprising the step of providing the granules with a density at least equal to that of the flowable resin matrix.

27. The method as described in claim 17, further comprising the step of applying an uppermost protective top coat upon the viewable surface associated with the three dimensional article.

28. The method as described in claim 17, further comprising the step of aligning the granules and such that they follow any irregular surface associated with a non-continuous three dimensional article.

29. The method as described in claim 17, further comprising the step of abradingly removing a portion of the viewable surface associated with the three dimensional formed article to reveal at least an uppermost volume of entrained granules.

30. The method as described in claim 26, further comprising the step of removing between 0.3 mil to 10 mils of the viewable surface.

31. A method for manufacturing a thermoplastic based article, comprising the steps of:
feeding a thermoplastic based resin into an extruder;
co-feeding a volume of a granule material substantially at a downstream location relative to a substantial input point associated with the resin material; and
providing the granules with an aspect ratio of at least 4 as defined between its average planar dimension and thickness.

32. The method as described in claim 31, further comprising the step of coloring said granules including introducing at least one resin component prior to introduction into said extruder.

33. The method as described in claim 31, further comprising the step of the granules exhibiting up to 0.6″ in planar dimension upon traveling a distance of at least 6″ along a barrel assembly.

34. The method as described in claim 31, further comprising the step of color controlling the granules to exhibit at least two visually differentiable colors in the resultant article created.

35. The method as described in claim 34, further comprising the step of coloring said granules in order to create a substantial portion of a color hue

36. The method as described in claim 34, further comprising the step of at least ⅓ of the granules changing at least one of a color, hue, shape, or size during processing.

37. The method as described in claim 31, further comprising the step of extruding the granule entrained thermoplastic compound into a sheet via removal of substantially all screens and blockages in an associated extrusion process finer than a 50 mesh rating.

38. The method as described in claim 28, further comprising the step of curing a three dimensional and substantially planar sheet article created into at least two strata therein.

39. The method as described in claim 38, further comprising the step of a specified one of the layers defining a granule-containing layer and exhibiting a thickness of between 0.006″ to 0.55″.

40. The method as described in claim 39, further comprising the step of creating a laminar-like flow during formation of a three dimensional sheet, such that at least 20% of granules above 0.1″ in planar dimension substantially align themselves parallel to one another as well as to a viewable surface of the sheet.

41. The method as described in claim 38, further comprising the step of mechanically removing a portion of a topmost layer to apply a mechanical-abrasive finish thereto.

42. The method as described in claim 31, further comprising the step of providing the thermoplastic based resin with at least one of a olefin, acrylic, polycarbonate and ABS material.

43. The method as described in claim 38, further comprising the step of coextruding an opaque backer layer onto a rear associated surface of a primary sheet.

44. The method as described in claim 43, further comprising the step of coextruding a clear protective cap onto a top associated surface of the primary sheet.

45. The method as described in claim 44, further comprising the step of abrasively planning the sheet top surface to a depth of not less than 0.01″ and not more than 0.25″.

46. The method as described in claim 38, further comprising the step of heating the sheet and drawing it over a wood-based substrate material conforming to at least one of a shelf countertop, door, molding, or architectural improvement.

47. The method as described in claim 38, further comprising the step of creating a total sheet thickness in a range of between 0.018″ to 0.120″.

48. The method as described in claim 38, further comprising the step of providing the granule less than 40 US mesh, and clearing obstructions from the system below 70 US mesh.

49. The method as described in claim 48, further comprising the step of adding an opacifying agent including at least one of a pigment or a comparable dispersion dye to the granule-containing layer to create a stronger background color.

50. The method as described in claim 49, further comprising the step of extruding the resin granule mixture into a sheet, and thermoforming the sheet over a wood-based scrim, the sheet exhibiting a thickness of between 0.02″ to 0.1″.

51. A method for forming an elongated thermoplastic article, comprising the steps of:
mixing a thermoplastic material with a plurality of granules, at least 2% of which thereof exhibit an average aspect ratio greater than two;
forming said thermoplastic material into an article maintained in a semi-molten and substantially sheet shape exhibiting a selected length, width and thickness;
applying a tensile and substantially linear directed force along at least one of first and second opposite extending edges comprising said sheet, the creation of hydrodynamic forces within said sheet causing said aspect ratio granules to align such that a greatest lineal dimension of each extends substantially parallel to an associated surface of said sheet; and
hardening said sheet.

52. A method for forming an elongated thermoplastic article, comprising the steps of:
mixing a thermoplastic material with a plurality of granules, at least 2% of which thereof exhibit an average aspect ratio greater than two;
forming said thermoplastic material into a sheet exhibiting a selected length, width and thickness;
heating said sheet up to a heat deformation temperature;
applying a tensile and substantially linear directed force along at least one of first and second opposite extending edges comprising said sheet, the creation of hydrodynamic forces within said sheet causing said aspect ratio granules to align such that a greatest lineal dimension of each extends substantially parallel to an associated surface of said sheet; and
re-hardening said sheet.

53. The method as described in claim 52, said step of applying a further tensile directed force further comprising elongating said sheet up to an additional 10% of it its original greatest dimension.

54. The method as described in claim 52, further comprising the step of bending said sheet into a substantially non-planar configuration.
